(19) United States
(12) Patent Application Publication
(10) Pub. No.: US 2015/0186920 A1
(43) Pub. Date: Jul. 2, 2015

(54) Optimizing and Distributing Discounts

(71) Applicant: SPOTLUCK LLC, Bethesda, MD (US)

(72) Inventors: Bradford Jeffrey Sayler, North Potomac, MD (US); Cherian Thomas, Bethesda, MD (US)

(73) Assignee: SPOTLUCK LLC, Bethesda, MD (US)

(21) Appl. No.: 14/285,928

(22) Filed: May 23, 2014

Related U.S. Application Data
(60) Provisional application No. 61/976,282, filed on Apr. 7, 2014.
(60) Provisional application No. 61/922,256, filed on Dec. 31, 2013.

(51) Int. Cl. G06Q 30/02

(52) U.S. Cl. CPC G06Q 30/0239

(57) ABSTRACT

Methods, systems, computer-readable media, and apparatuses for optimizing and distributing discounts are presented. In some embodiments, a computing device may receive a request for a randomized discount. In response to receiving the request for the randomized discount, the computing device, may select a merchant from a hub that includes at least two merchants grouped based on geographical proximity of business locations of the at least two merchants. Subsequently, the computing device may determine a discount for the selected merchant. The computing device then may cause the determined discount for the selected merchant to be presented.

### CROSS-REFERENCE TO RELATED APPLICATIONS

This application claims the benefit of U.S. Provisional Patent Application Ser. No. 61/922,256, filed Dec. 31, 2013, and entitled “Discount Disbursement Method and System,” and U.S. Provisional Patent Application Ser. No. 61/976,282, filed Apr. 7, 2014, and entitled “Mobile Marketing Platform.” Each of the foregoing applications is incorporated by reference herein in its entirety.

### BACKGROUND

Aspects of the disclosure relate to computing hardware and computer software. In particular, one or more aspects of the disclosure are directed to computing hardware and computer software for optimizing and distributing discounts.

Many people are increasingly using mobile devices and other computing devices for various functions. One way that people are using such devices is to look for and take advantage of coupons, deals, and other discounts that may be made available by various retailers and other businesses for many different types of products and services. As people increasingly use mobile devices to obtain such discounts, it may difficult, if not overwhelming, for an individual user to find appropriate and/or appealing discounts among the multitude of discounts that may be available from various businesses and online discount aggregators. It may likewise be difficult for businesses to find a balance between providing discounts that attract more customers while keeping discounted prices for goods and services high enough to still make a profit.

### SUMMARY

Aspects of the disclosure relate to various systems and techniques that provide efficient, effective, scalable, and convenient ways of optimizing and distributing discounts, particularly in ways that maximize profitability for merchants while still attracting customers with discounted prices for goods and services. In addition, aspects of the disclosure provide more convenient and easy-to-use ways for end users to find and take advantage of discounts that are not only available to them, but also appealing, attractive, and relevant to such users.

In accordance with one or more embodiments, a computing device may receive a request for a randomized discount. In response to receiving the request for the randomized discount, the computing device may select a merchant from a hub, and the hub may include at least two merchants grouped based on geographical proximity of business locations of the at least two merchants. Subsequently, the computing device may determine a discount for the selected merchant. The computing device then may cause the determined discount for the selected merchant to be presented.

In some embodiments, the geographical proximity of the business locations of the at least two merchants may be determined based on each of the business locations being physically located within a predetermined distance of each other. Additionally or alternatively, the determined discount for the selected merchant may be determined based on one or more factors, including time of day, day of year, current weather, an amount of distance between an intended recipient of the determined discount and the selected merchant, user-specific preferences, use-specific factors, and/or one or more popularity factors.

In one or more additional embodiments, a computing device may receive, from a user computing device, a request for a randomized discount for a user of the user computing device. In response to receiving the request for the randomized discount for the user of the user computing device, the computing device may select a merchant from a group of at least two merchants using a randomized process, and the at least two merchants may be grouped based on geographical proximity of the at least two merchants. Subsequently, the computing device may determine a discount that is redeemable by the user of the user computing device with the merchant. The computing device then may provide, to the user computing device, the determined discount.

In one or more additional embodiments, a computing device may present hub listing information identifying one or more hubs. Subsequently, the computing device may receive a selection of a first hub of the one or more hubs, and the first hub may include a group of at least two merchants that are grouped into the first hub based on geographical proximity. Thereafter, the computing device may receive a request for a randomly-selected randomized discount. Based on receiving the request for the randomly-selected randomized discount, the computing device may present a big discount that is redeemable with a randomly-selected merchant of the at least two merchants. In addition, the computing device may present one or more base discounts, and the one or more base discounts may include at least one base discount for each merchant of the at least two merchants other than the randomly-selected merchant. The computing device then may receive a selection of one of the presented discounts. Subsequently, the computing device may communicate discount selection information identifying the selected discount.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device in accordance with one or more illustrative aspects of the disclosure;

FIG. 2 depicts an example of a computing environment for optimizing and distributing discounts in accordance with one or more illustrative aspects of the disclosure;

FIGS. 3A-3Q depict an example of an event sequence for optimizing and distributing discounts in accordance with one or more illustrative aspects of the disclosure;

FIGS. 4-12 depict examples of graphical user interfaces that may be presented in optimizing and distributing discounts in accordance with one or more illustrative aspects of the disclosure;

FIG. 13 depicts an example of a method of optimizing and distributing discounts in accordance with one or more illustrative aspects of the disclosure;

FIG. 14 depicts another example of a method of optimizing and distributing discounts in accordance with one or more illustrative aspects of the disclosure;

FIG. 15 depicts another example of a method of optimizing and distributing discounts in accordance with one or more illustrative aspects of the disclosure; and

FIG. 16 depicts an example method of determining discounts based on hub and business data in accordance with various aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

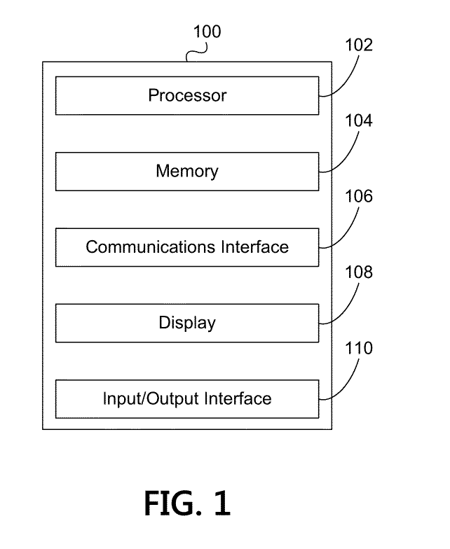

FIG. 1 depicts an example of a computing device in accordance with one or more illustrative aspects of the disclosure. As seen in FIG. 1, computing device 100 may include a processor 102, memory 104, communications interface 106, display 108, and an input/output (I/O) interface 110. Processor 102 may control various operations of the computing device 100, which may include controlling and/or otherwise interacting with various components of the computing device, including memory 104, communications interface 106, display 108, and/or I/O interface 110. Memory 104 may store computer-readable instructions that may, for example, be executed by processor 102. In addition, memory 104 may store applications and/or other data that may be used in implementing various aspects of the disclosure. Communications interface 106 may include one or more wired communication interfaces (e.g., an Ethernet interface), one or more wireless communication interfaces (e.g., a wireless local area networking (WLAN) interface, a Bluetooth interface, etc.), and/or one or more other communication interfaces. Communications interface 106 may, for example, enable computing device 100 to exchange information and/or electronic signals with one or more other computing devices via one or more communication networks or connections. Display 108 may include a video display unit via which computing device 100 may provide image and/or video output. In some instances, display 108 may include a touch-sensitive surface that may receive touch-based input (e.g., from a user of computing device 100 provided by a stylus, the user's finger, etc.). I/O interface 110 may include a camera, a microphone, an audio speaker, one or more ports, and/or other components that may enable computing device 100 to receive various types of input and/or provide various types of output.

Computing device 100 provides an example of a generic computing device that may be used in implementing various aspects of the disclosure. For example, one or more of the computing platforms, servers, and/or other computing devices discussed below may incorporate one or more aspects of computing device 100. While computing device 100 provides one example arrangement of a computing device, one or more aspects of the disclosure may be similarly implemented in computing devices having other arrangements. For example, in some alternative arrangements, a computing device may include one or more additional and/or alternative components in addition to and/or instead of those discussed here. For instance, in some alternative arrangements, a computing device may include multiple instances of the components shown in FIG. 1 and/or other components (e.g., two or more processors, two or more memories, two or more displays, etc.).

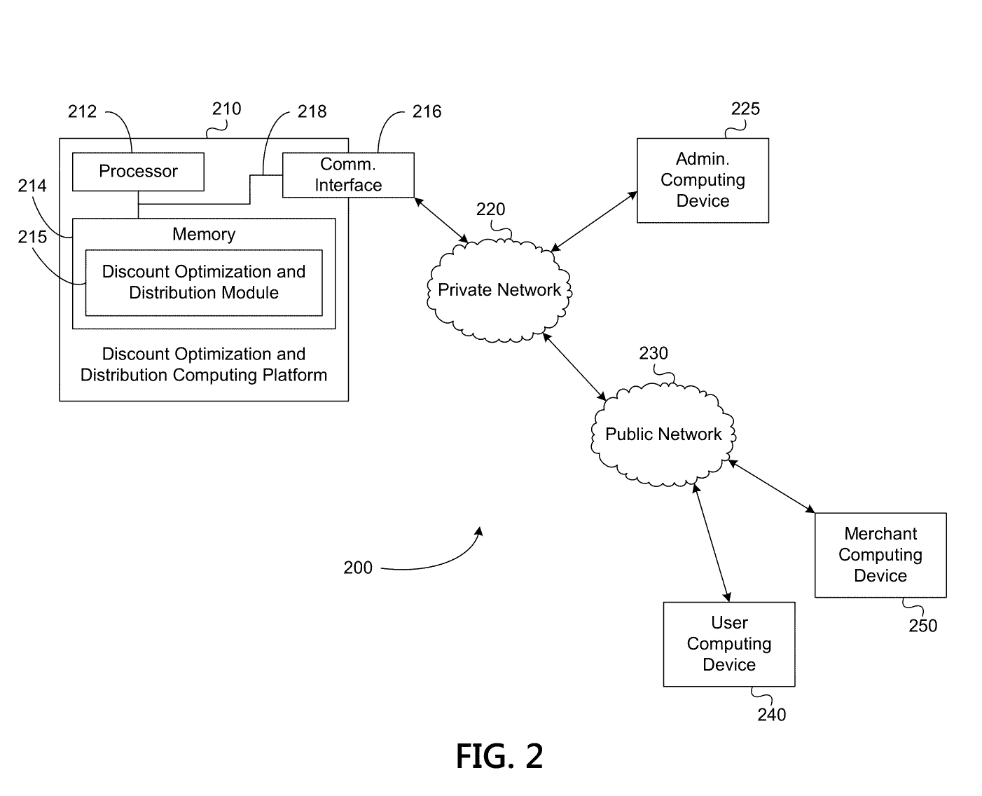

FIG. 2 depicts an example of a computing environment for optimizing and distributing discounts in accordance with one or more illustrative aspects of the disclosure. As seen in FIG. 2, computing environment 200 may include one or more computing devices. For example, computing environment 200 may include an administrative computing device 225 (which may, e.g., be used by an administrative user of a discount optimization and distribution system), a user computing device 240 (which may, e.g., be used by an end user who obtains and/or utilizes a discount via a discount optimization and distribution system), and a merchant computing device 250 (which may, e.g., be used by a merchant user who provides and/or redeems a discount via a discount optimization and distribution system). Administrative computing device 225, user computing device 240, and merchant computing device 250 may incorporate one or more aspects of generic computing device 100 and may be any type of computing device capable of receiving a user interface, receiving input via the user interface, and communicating the received input to one or more other computing devices. For example, administrative computing device 225, user computing device 240, and merchant computing device 250 may be a desktop computer, laptop computer, tablet computer, smart phone, or the like.

Computing environment 200 also may include one or more computing platforms. For example, computing environment 200 may include a discount optimization and distribution computing platform 210. Discount optimization and distribution computing platform 210 may include one or more computing devices configured to perform one or more of the functions described herein. For example, discount optimization and distribution computing platform 210 may include one or more computers (which may, e.g., incorporate one or more aspects of generic computing device 100).

Computing environment 200 also may include one or more networks, which may interconnect one or more of discount optimization and distribution computing platform 210, administrative computing device 225, user computing device 240, and merchant computing device 250. For example, computing environment 200 may include a private network 220 and a public network 230. Private network 220 and/or public network 230 may include one or more sub-networks (e.g., LANs, WANs, or the like). Private network 220 may be associated with a particular organization (e.g., a corporation, partnership, or the like) and may interconnect one or more computing devices associated with the organization. For example, discount optimization and distribution computing platform 210 and administrative computing device 225 may be associated with an organization (e.g., a company that helps various merchants create, optimize, and distribute discounts to potential customers), and private network 220 may be associated with and/or operated by the organization, and may include one or more networks (e.g., local area networks (LANs), wide area networks (WANs), virtual private networks (VPNs), or the like) that interconnect discount optimization and distribution computing platform 210 and administrative computing device 225. Public network 230 may connect private network 220 and/or one or more computing devices connected thereto (e.g., discount optimization and distribution computing platform 210 and administrative computing device 225) with one or more networks and/or computing devices that are not associated with the organization. For example, user computing device 240 and merchant computing device 250 might not be associated with an organization that operates and/or is otherwise associated with private network 220, and public network 230 may include one or more networks (e.g., the Internet) that connect user computing device 240 and/or merchant computing device 250 to private network 220 and/or one or more computing devices connected thereto (e.g., discount optimization and distribution computing platform 210 and administrative computing device 225).

Discount optimization and distribution computing platform 210 may include at least one processor 212, memory 214, communication interface 216, and data bus 218. Data bus 218 may interconnect processor 212, memory 214, and/or communication interface 216. Communication interface 216 may be a network interface configured to support communication between discount optimization and distribution computing platform 210 and private network 220 or one or more sub-networks thereof. Memory 214 may include one or more program modules comprising instructions that, when executed by processor 212, cause discount optimization and distribution computing platform 210 to perform one or more functions described herein. For example, memory 214 may include discount optimization and distribution module 215, which may include instructions that, when executed by processor 212, cause discount optimization and distribution computing platform 210 to perform data processing for determining an optimized discount and to distribute the optimized discount to one or more user computing devices.

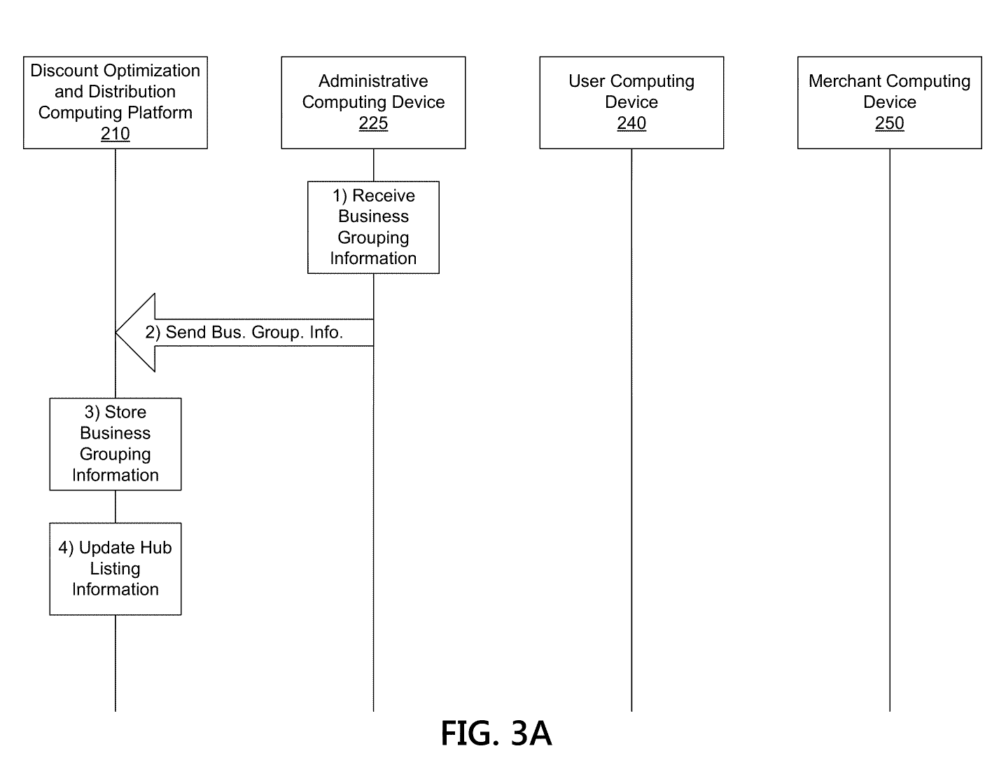

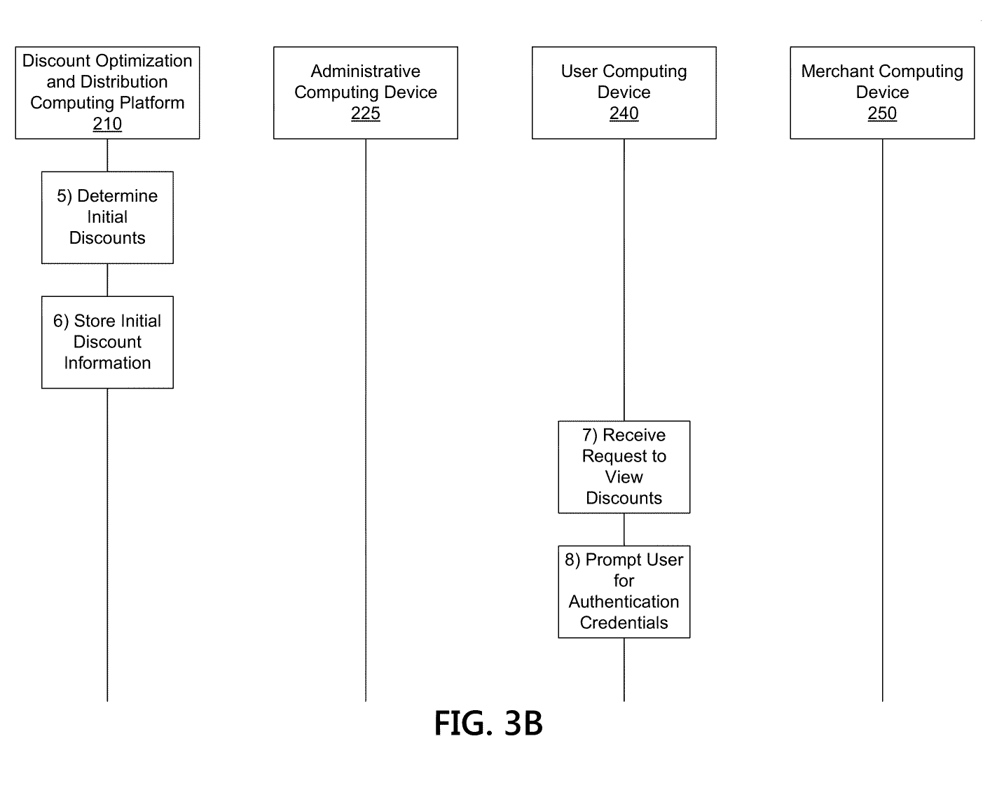

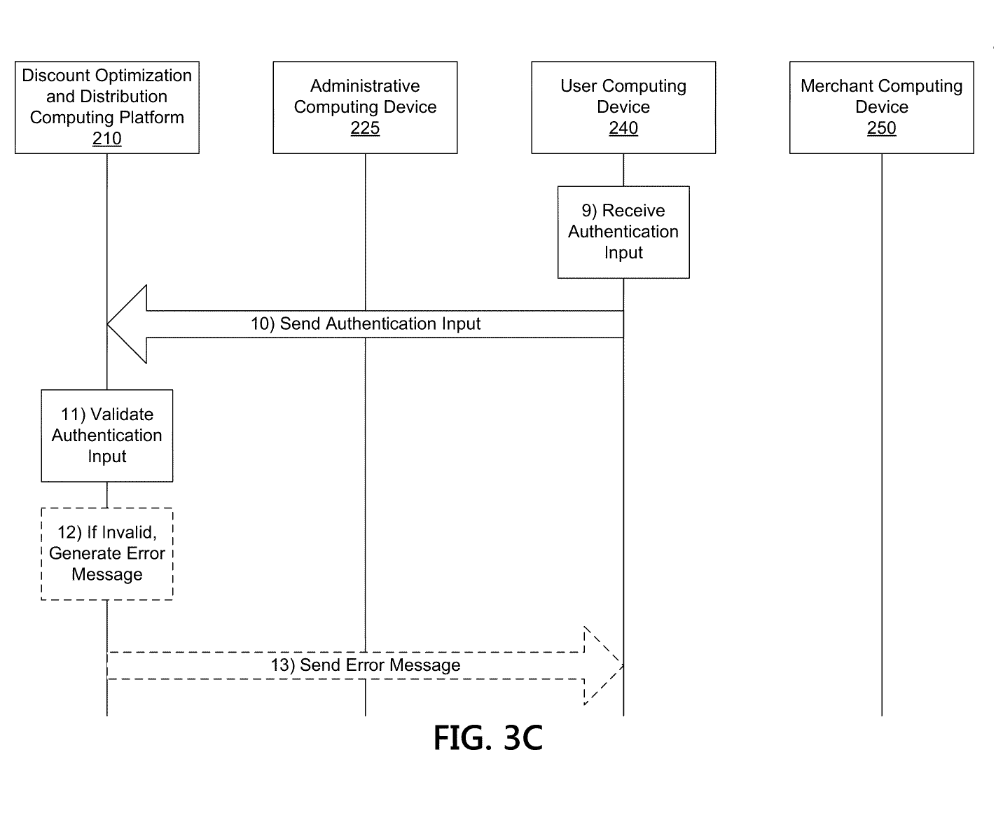

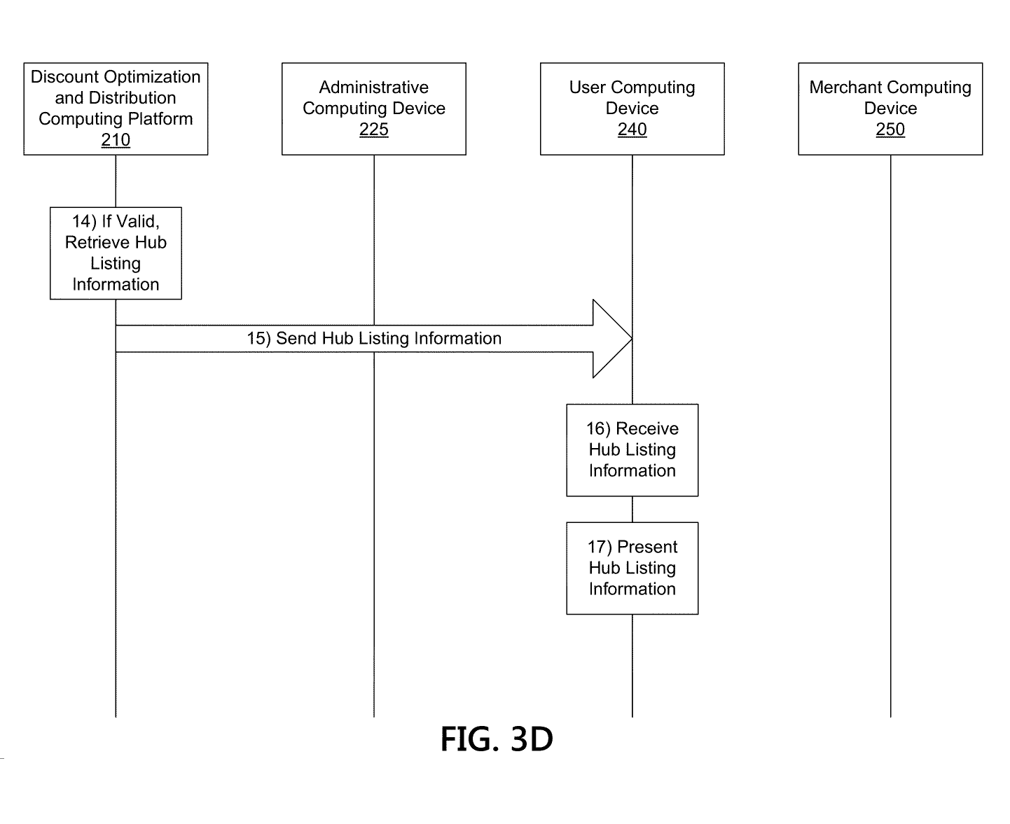

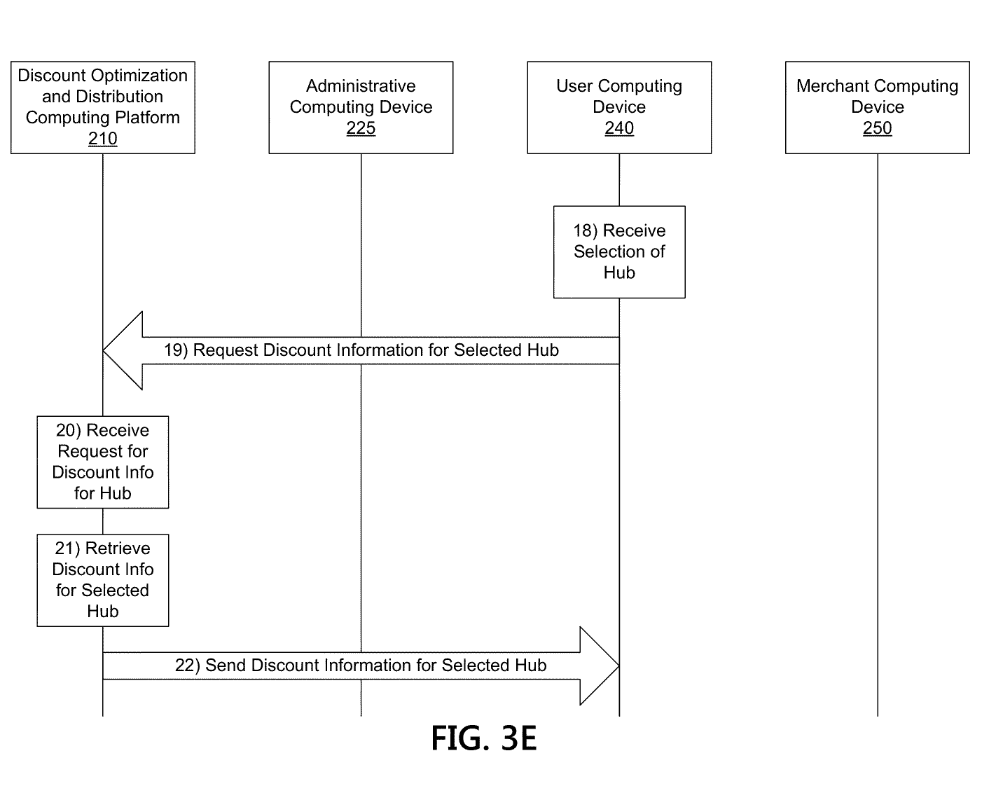

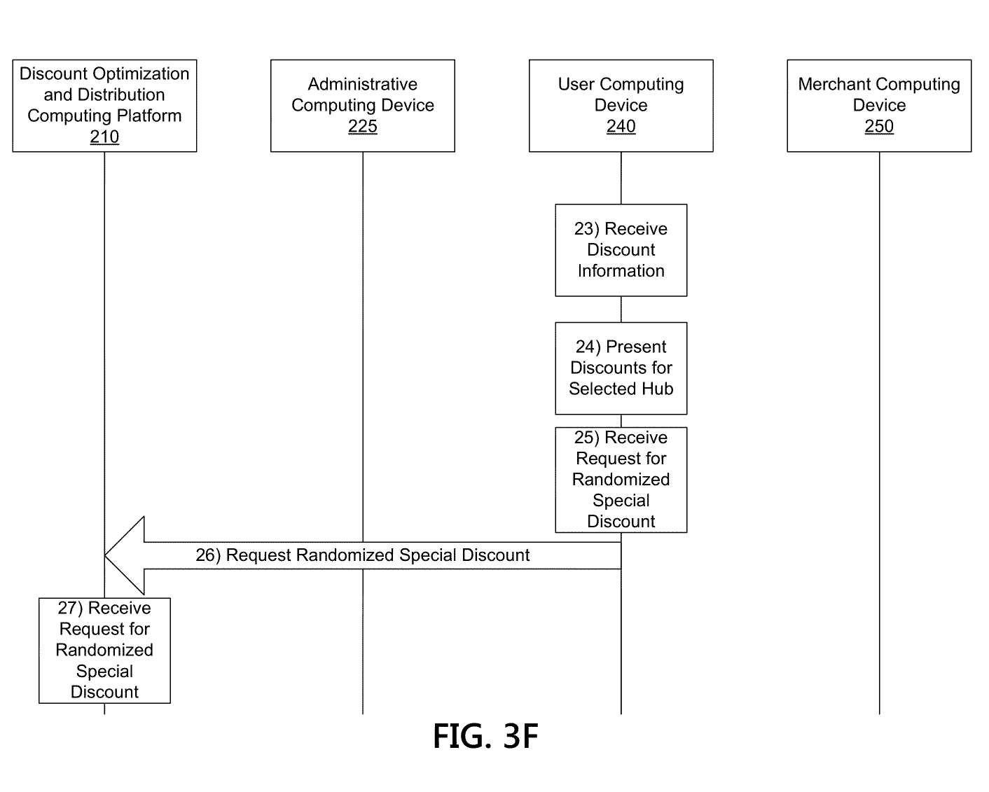

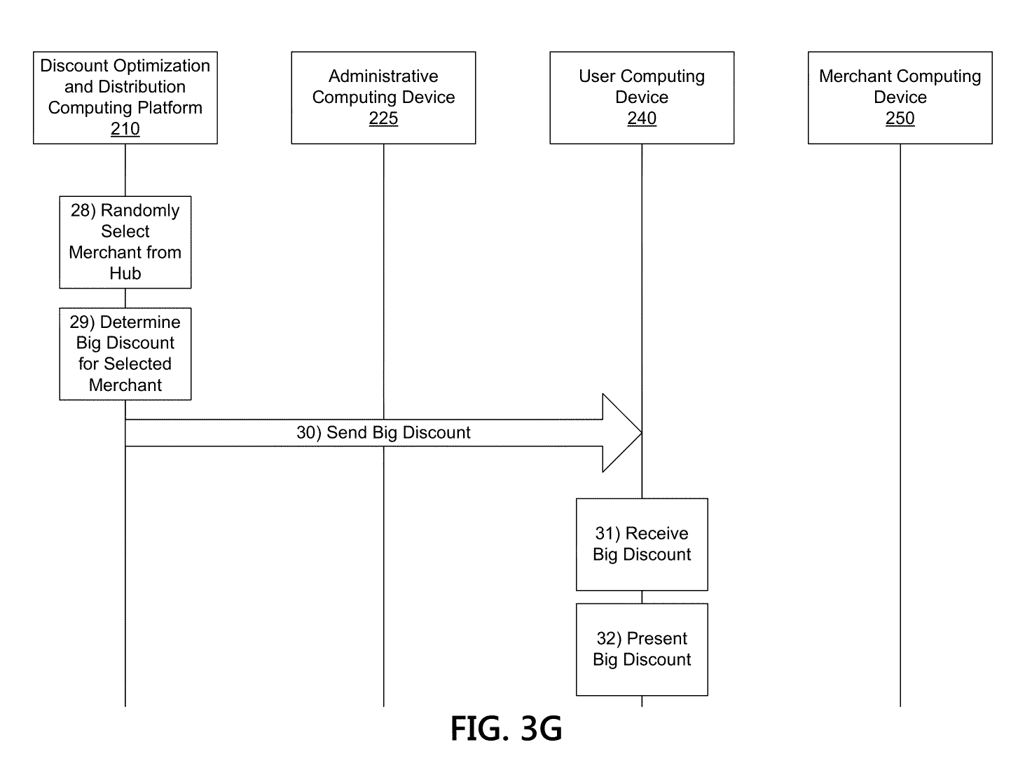

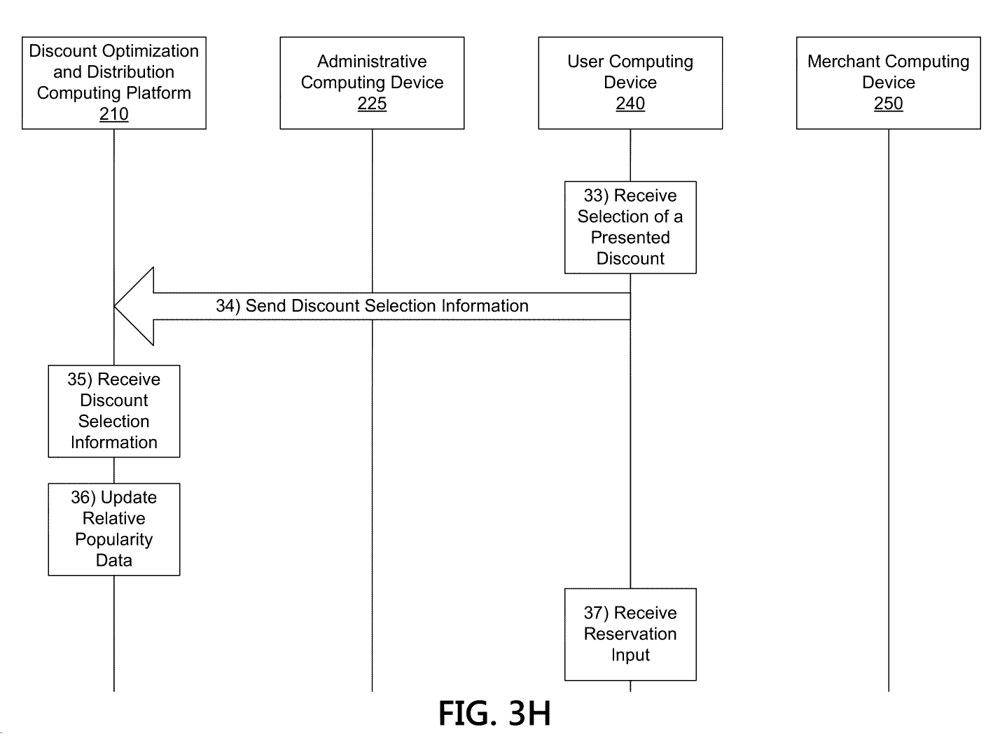

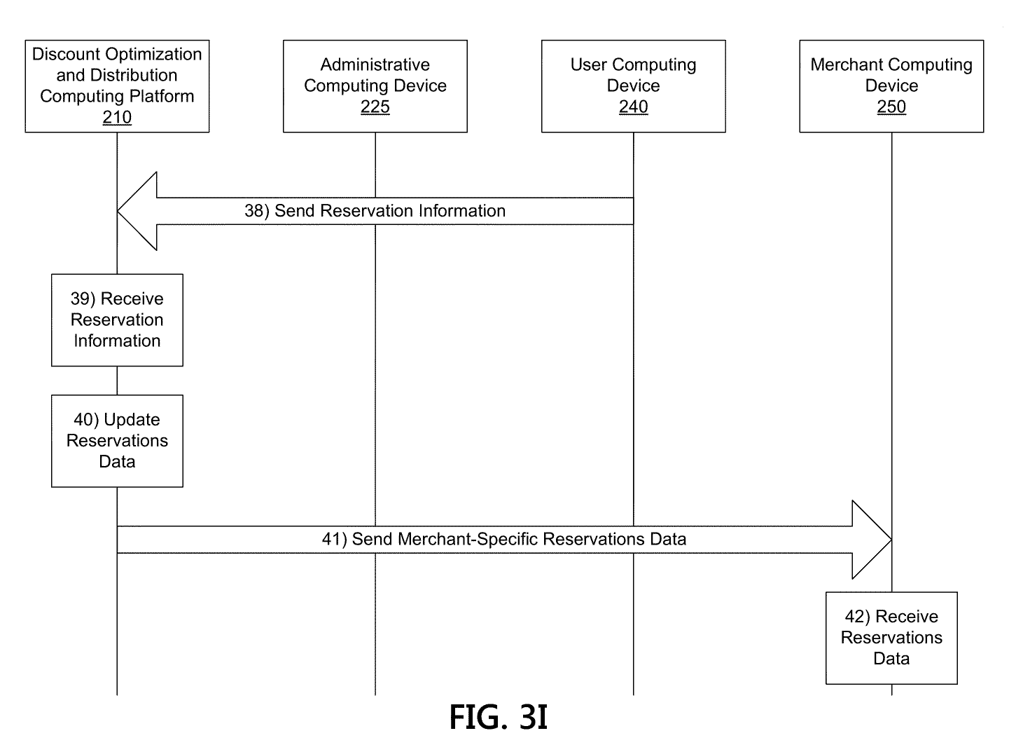

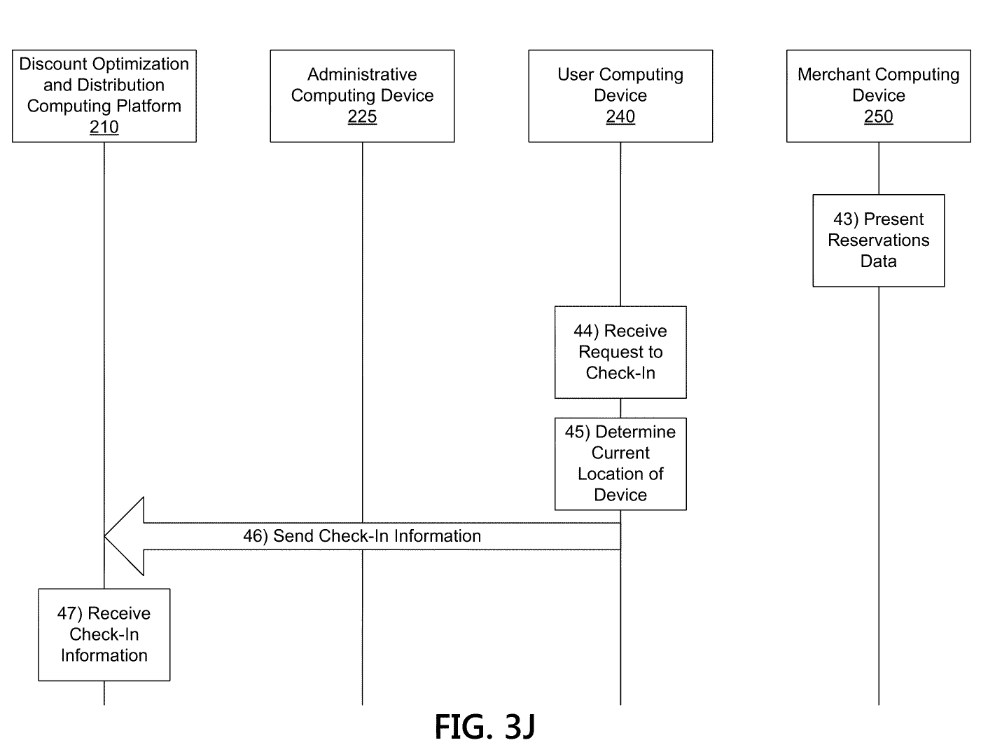

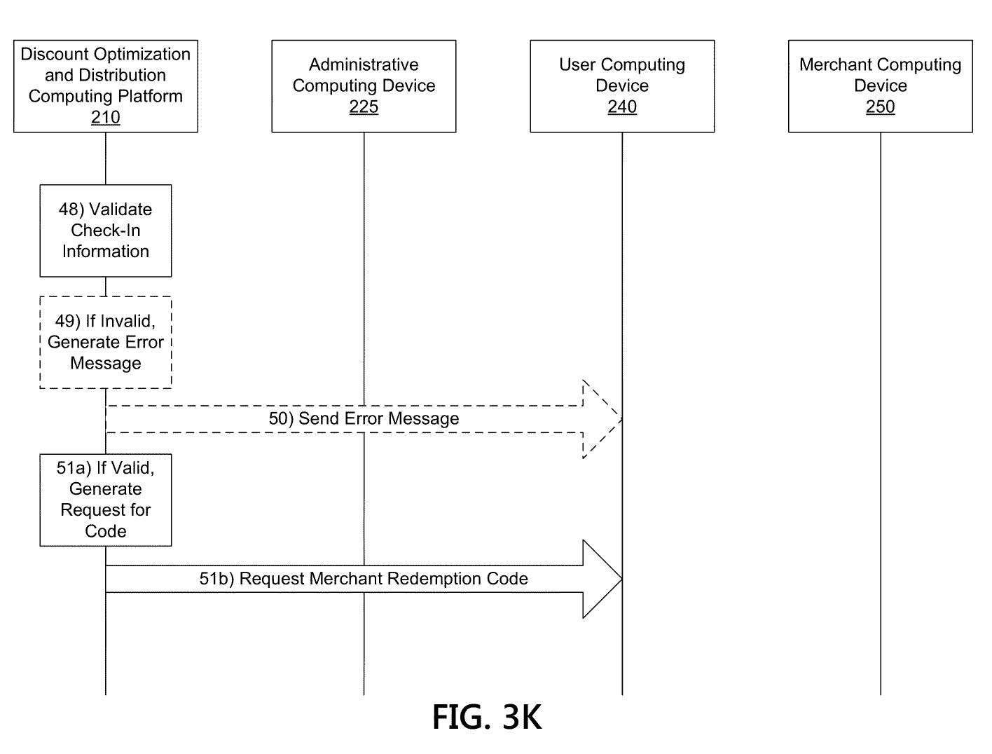

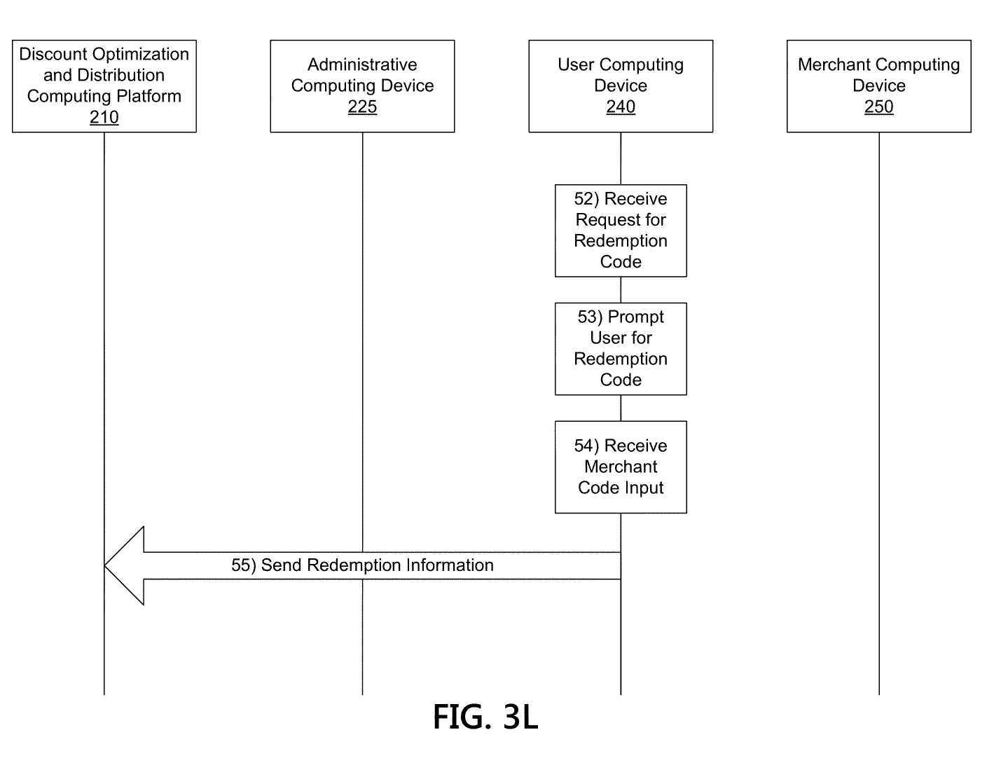

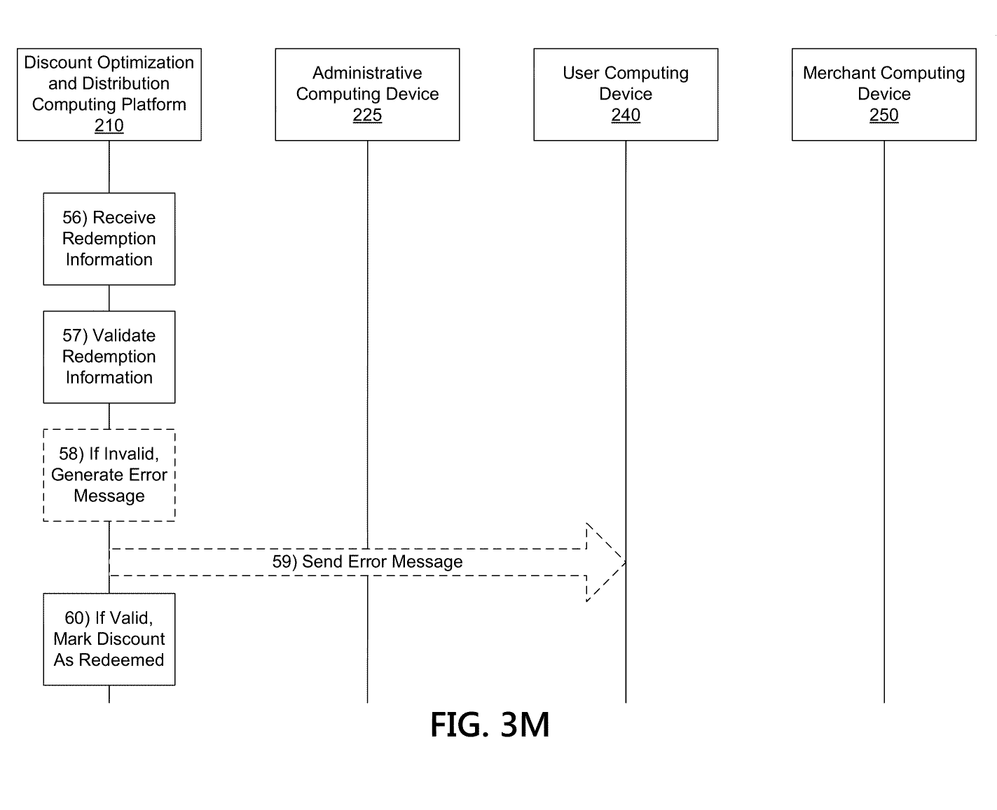

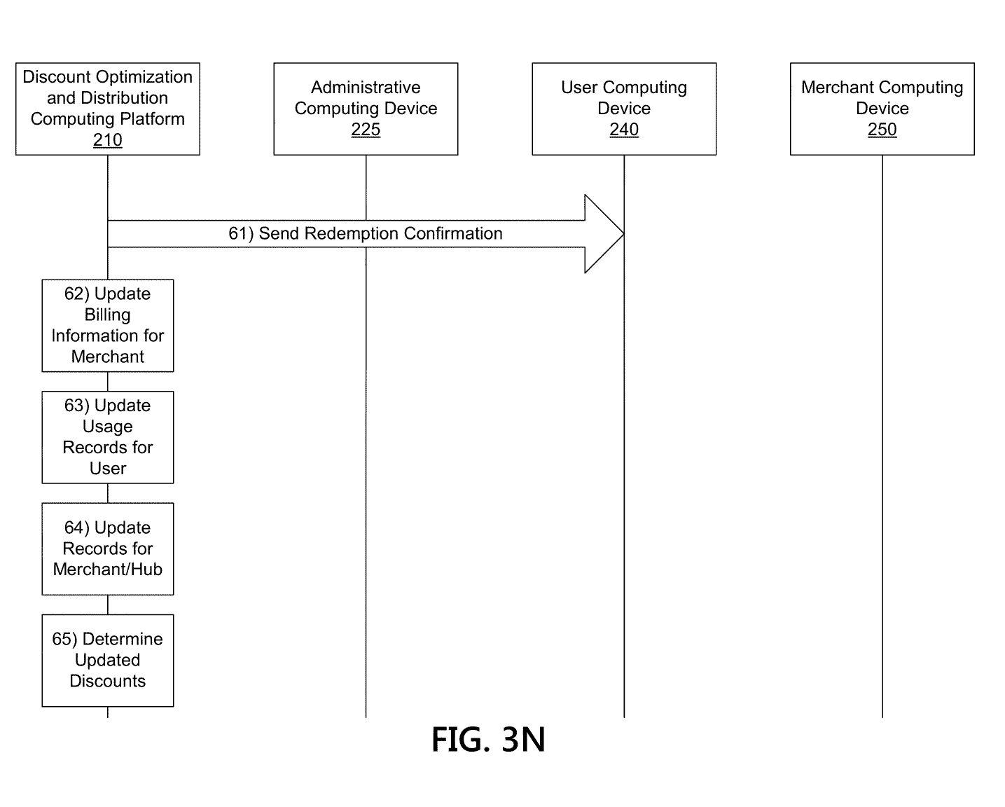

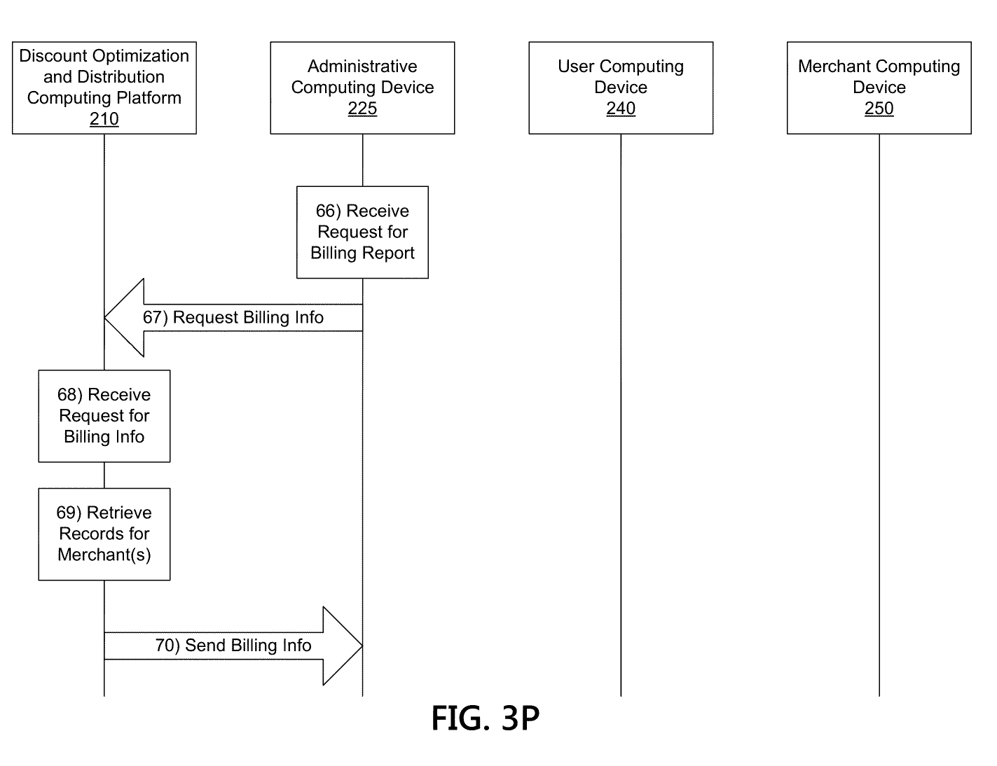

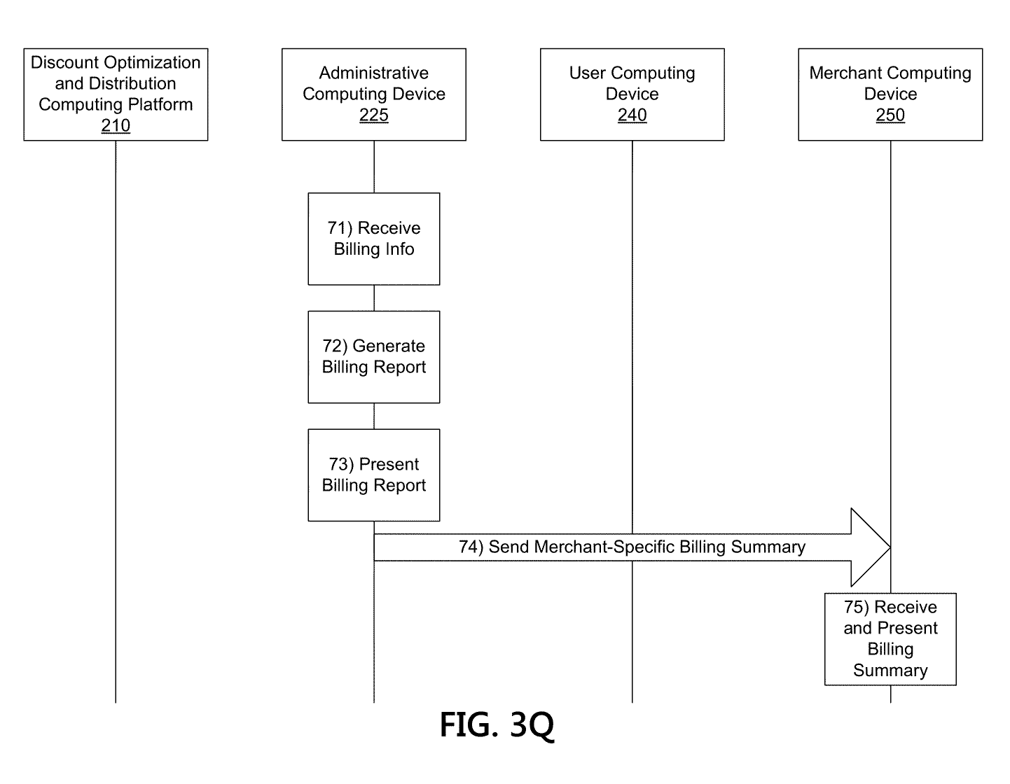

FIGS. 3A-3Q depict an example of an event sequence for optimizing and distributing discounts in accordance with one or more illustrative aspects of the disclosure.

Referring to FIG. 3A, at step 1, administrative computing device 225 may receive business grouping information. The business grouping information may, for example, be received from an administrative user via a graphical user interface provided by administrative computing device 225. In addition, the business grouping information may identify one or more merchants to be included in one or more new and/or existing hubs of merchants. Each hub of merchants may, for instance, be composed of a set of merchants that are grouped based on one or more characteristics, such as their location, the types of goods and/or services that they offer, and/or one or more other factors. The business grouping information that is received by administrative computing device 225 at step 1 may, for example, identify one or more businesses to be added to a particular hub, one or more businesses to be removed from a particular hub, and/or one or more other changes to be made to a particular hub.

In one or more embodiments, merchants may be selected for inclusion in a particular hub based on the geographical proximity of their business locations. For example, the business locations of different merchants in a hub may be physically located within a predetermined distance of each other (e.g., within one mile of each other, within five miles of each other, etc.). Additionally or alternatively, merchants may be selected for inclusion in a particular hub based on the merchants providing one or more common goods and/or services. For example, the merchants included in a particular hub may, in some embodiments, be restaurants that are physically located within a predetermined distance of each other. Although each individual restaurant may offer a different type of cuisine (e.g., sandwiches, pizza, sushi, etc.) in such an arrangement, the restaurants may be selected for inclusion in a hub based on their geographical proximity and their common offering of dining services. In this way, each hub may be a hyper-local group of businesses, such as a group of restaurants, that compete primarily based on price and quality due to their proximity to each other. As illustrated below, the hyper-local nature of the grouping of restaurants and/or other merchants selected for inclusion in a hub may enable discounts to be optimized and distributed to potential customers of these merchants, and such discounts may be optimized using an economic analysis that accounts for geographical proximity of the merchants.

At step 2, administrative computing device 225 may communicate the received business grouping information to discount optimization and distribution computing platform 210 (e.g., by sending, transmitting, and/or otherwise communicating the received business grouping information to discount optimization and distribution computing platform 210). At step 3, discount optimization and distribution computing platform 210 may store the business grouping information received from administrative computing device 225. Discount optimization and distribution computing platform 210 may store the business grouping information in one or more databases that are stored and/or maintained by discount optimization and distribution computing platform 210 and/or otherwise accessible to discount optimization and distribution computing platform 210. At step 4, discount optimization and distribution computing platform 210 may update hub listing information. For example, at step 4, discount optimization and distribution computing platform 210 may update hub listing information that identifies various hubs, the various merchants included in each hub, and/or other information associated with the various hubs based on the business grouping information. Such hub listing information may, for example, be stored and/or maintained by discount optimization and distribution computing platform 210 and/or may be stored and/or maintained in the one or more databases in which the business grouping information is stored.

At step 5, discount optimization and distribution computing platform 210 may determine one or more initial discounts for the merchants included in one or more hubs (which may, e.g., be identified in the hub listing information). The one or more initial discounts may, for instance, be discounts that are dynamically generated by discount optimization and distribution computing platform 210 and offered by discount optimization and distribution computing platform 210 to one or more potential customers of the merchants, as discussed below. In addition, the one or more discounts may be determined based on various factors and/or other considerations. For example, discount optimization and distribution computing platform 210 may determine an initial discount for a particular merchant included in a particular hub based on one or more factors including total discount uses (which may, e.g., reflect the number of discounts that have been offered on behalf of and/or redeemed at the merchant within a certain time period, such as within the last day, within the last week, etc.), total money spent (which may, e.g., reflect the amount of money that has been spent by various customers in redeeming discounts at the merchant within a certain time period, such as within the last day, within the last week, etc.), average distance traveled (which may, e.g., reflect the average distance traveled by customers in redeeming discounts at the merchant within a certain time period, such as within the last day, within the last week, etc.), total passes on large discounts (which may, e.g., reflect a number of times that potential customers have opted not to use a relatively larger discount, or big discount as discussed below, at the merchant within a certain time period, such as within the last day, within the last week, etc. in favor of a smaller discount at a different merchant), user ratings (which may, e.g., reflect ratings of the merchant provided by previous customers), blackouts (which may, e.g., reflect dates and/or times that have been blocked out for discount offers and/or discount redemption by the merchant), and/or knockouts (which may, e.g., reflect the number of times that potential customers have chosen to exclude the merchant from a hub).

Any and/or all of the information that may be used by discount optimization and distribution computing platform 210 in determining initial discounts for the merchants (e.g., at step 5) may be obtained from one or more databases that are stored and/or maintained by discount optimization and distribution computing platform 210 and/or otherwise accessible to discount optimization and distribution computing platform 210.

At step 6, discount optimization and distribution computing platform 210 may store initial discount information that may identify and/or otherwise include the initial discounts determined at step 5 by discount optimization and distribution computing platform 210 for one or more merchants in one or more hubs.

At step 7, user computing device 240 may receive a request to view one or more discounts. The request to view the one or more discounts may, for example, be received from a user of user computing device 240 and may, in some instances, include a user-initiated command to open a software application that is distributed and/or otherwise provided by an organization operating discount optimization and distribution computing platform 210. At step 8, user computing device 240 may prompt the user for one or more authentication credentials, such as a username and password that the user may have used in previously registering with discount optimization and distribution computing platform 210. At step 9, user computing device 240 may receive authentication input from the user of user computing device 240. In some instances, the authentication input may include a username and password entered by the user of user computing device 240. In other instances, the authentication input that is received at step 9 may include a single sign-on (SSO) credential provided by the user that may, for example, be validated by and/or otherwise associated with another organization or service, such as a social networking service, different from the organization that may operate discount optimization and distribution computing platform 210.

At step 10, user computing device 240 may communicate the received authentication input to discount optimization and distribution computing platform 210. At step 11, discount optimization and distribution computing platform 210 may validate the authentication input received from user computing device 240 (e.g., by comparing the received authentication input with information identifying one or more valid username-and-password combinations). If discount optimization and distribution computing platform 210 determines that the authentication input is invalid (e.g., at step 11), then at step 12, discount optimization and distribution computing platform 210 may generate an error message, and at step 13, discount optimization and distribution computing platform 210 may send the generated error message to user computing device 240.

Alternatively, if discount optimization and distribution computing platform 210 determines that the authentication input is valid (e.g., at step 11), then at step 14, discount optimization and distribution computing platform 210 may retrieve hub listing information. For example, at step 14, discount optimization and distribution computing platform 210 may retrieve the hub listing information that was previously stored and/or that may be otherwise maintained by discount optimization and distribution computing platform 210 and which may include information about various hubs and/or the various merchants that may be included in each hub.

At step 15, discount optimization and distribution computing platform 210 may communicate the hub listing information to user computing device 240. For example, at step 15, discount optimization and distribution computing platform 210 may communicate, via communication interface 216, to user computing device 240, hub listing information identifying one or more hubs. Each hub of the one or more hubs may include at least two merchants, and in many instances, each hub may include more than two merchants. For example, a hub may often include between six and twelve merchants, but may, in some instances, include more or less. In addition, each of the merchants included in the hub may be selected for inclusion in the hub based on geographical proximity of their business locations. In particular, the geographical proximity of the business locations of the at least two merchants may be determined based on each of the business locations being physically located within a predetermined distance of each other (e.g., within one mile of each other, within two miles of each other, within five miles of each other, etc.). In one or more embodiments, each merchant of the at least two merchants included in the one or more hubs may be a restaurant, and in these embodiments, discount optimization and distribution computing platform 210 may be configured to optimize and distribute discounts to various customers (such as the user of user computing device 240) on behalf of the various restaurants included in each hub of the one or more hubs.

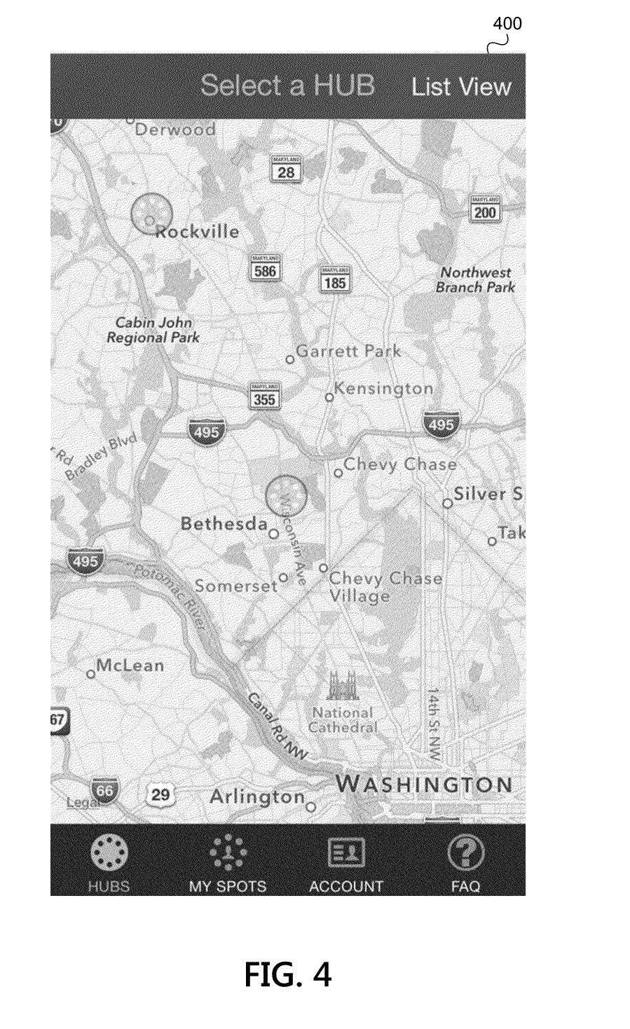

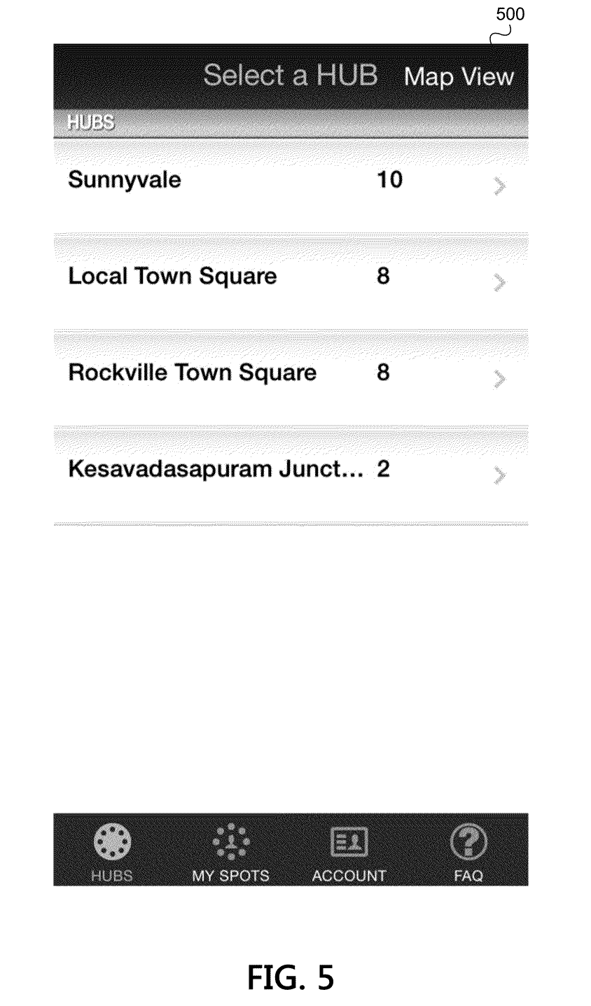

At step 16, user computing device 240 may receive the hub listing information from discount optimization and distribution computing platform 210. At step 17, user computing device 240 may present the hub listing information received from discount optimization and distribution computing platform 210. For instance, at step 17, user computing device 240 may present hub listing information identifying one or more hubs by displaying one or more graphical user interfaces that include information about the one or more hubs identified in the hub listing information and/or by causing such graphical user interfaces to be displayed. For example, user computing device 240 may generate, display, and/or otherwise present a graphical user interface similar to graphical user interface 400, depicted in FIG. 4, which may be configured to allow a user of user computing device 240 to select a hub from a map. Additionally or alternatively, user computing device 240 may generate, display, and/or otherwise present a graphical user interface similar to graphical user interface 500, depicted in FIG. 5, which may be configured to allow a user of computing device 240 to select a hub from a list.

In some embodiments, at least one hub of the one or more hubs (which may, e.g., be identified in the hub listing information presented by user computing device 240) may be a user-defined hub. For example, such a user-defined hub may be created by the user of user computing device 240 and may include at least two merchants selected for inclusion in the hub by the user of user computing device 240. In some instances, the user of user computing device 240 may create a user-defined hub by modifying a predefined hub, for instance, by knocking out or adding one or more merchants to a hub defined in the hub listing information based on business grouping information received from administrative computing device 225 and/or an administrative user thereof. The information that identifies one or more user-defined hubs for the user of user computing device 240 may, for example, be stored locally on user computing device 240 and/or may be centrally maintained by discount optimization and distribution computing platform 210.

Referring to FIG. 3E, at step 18, user computing device 240 may receive a selection of a hub (e.g., from a user of user computing device 240 via one or more of the graphical user interfaces discussed above). For example, at step 18, user computing device 240 may receive a selection of a first hub of the one or more hubs identified in the hub selection information. The first hub (which may, e.g., be selected by a user of user computing device 240 at step 18) may include a group of at least two merchants, and the at least two merchants may be grouped into the first hub (e.g., by discount optimization and distribution computing platform 210 and/or by an entity operating discount optimization and distribution computing platform 210) based on the geographical proximity of corresponding business locations of the at least two merchants. At step 19, user computing device 240 may request discount information for the selected hub. For example, at step 19, user computing device 240 may request discount information for the hub selected by the user of user computing device 240 at step 18.

At step 20, discount optimization and distribution computing platform 210 may receive the request for discount information from user computing device 240, and the received request may include hub selection information identifying the hub that the user selected and/or for which the discount information is being requested. For example, at step 20, discount optimization and distribution computing platform 210 may receive, via communication interface 216, from user computing device 240, hub selection information identifying a hub selected by the user of user computing device 240. As noted above, the hub selected by the user of user computing device may include at least two merchants.

At step 21, discount optimization and distribution computing platform 210 may retrieve discount information for the hub selected by the user of user computing device 240. For example, discount optimization and distribution computing platform 210 may retrieve the discount information that may have been determined and stored at steps 5 and 6 (discussed above) for the selected hub. Additionally or alternatively, discount optimization and distribution computing platform 210 may, at step 21, determine or update (e.g., re-calculate based on any changes in the data used in determining various discounts) one or more discounts for the hub selected by the user of user computing device 240 in order to generate discount information for the hub selected by the user of user computing device 240.

In determining one or more discounts for a hub, discount optimization and distribution computing platform 210 may, in some embodiments, determine the one or more discounts based on various factors and/or other considerations, such as the factors and considerations discussed above (e.g., with respect to steps 5 and 6). Additionally or alternatively, in determining one or more discounts for a hub, discount optimization and distribution computing platform 210 may determine the one or more discounts based on an economic analysis using one or more factors that include user-specific factors, hub-specific factors, use-specific factors, merchant-specific factors (e.g., one or more popularity factors), and/or other factors.

Such an economic analysis may target a “sweet spot” along an economic demand curve where the discount that is determined for each merchant in the hub creates a predicted and/or expected amount of demand at which profit for the merchant is maximized, even when the merchant is offering the discount. The user-specific factors that may be used in such an economic analysis may, for example, include user history (which may, e.g., include information about the particular user's previous visits to and/or purchases with the merchant), user profile rating (which may, e.g., include information about the particular user's previous rating of the merchant), and/or user demographics (which may, e.g., include information about the particular user's age, gender, education, income, address, etc.). The use-specific factors that may be used in such an economic analysis may, for example, include the current date and/or time, the distance between the particular user and the merchant (which may, e.g., be determined based on the distance between the current location of user computing device 240 and the location of the merchant's business location), and/or the current weather. For example, in bad weather, such as rain or snow, discount optimization and distribution computing platform 210 may determine a relatively larger discount for a particular merchant than in good weather, such as sunny or partly cloudy weather, all other factors being equal, as discount optimization and distribution computing platform 210 may determine that the relatively larger discount is needed to incentivize the user to visit and/or make a purchase with the merchant. Other use-specific factors that may, for example, be used in such an economic analysis include civil unrest, disease outbreak, and/or any other external factors that may affect demand at a merchant.

The one or more merchant-specific factors that may be used in the economic analysis may include one or more popularity factors, and the one or more popularity factors that may be used in the economic analysis may include one or more general popularity factors and/or one or more relative popularity factors. The one or more general popularity factors may, for example, include information associated with ratings and/or reviews of the merchant obtained and/or received from one or more external sources (e.g., sources that are not associated with the particular user, such as one or more third-party public ratings and/or review websites). The one or more relative popularity factors may, for example, include information that is collected by discount optimization and distribution computing platform 210 about the particular merchant and/or other merchants that may be included in the same hub as the merchant and/or in one or more different hubs. For example, the relative popularity factors may include information about the number of total number of discounts that have been redeemed and/or otherwise used with the particular merchant (which may, e.g., be evaluated by discount optimization and distribution computing platform 210 relative to the number of discounts that have been redeemed and/or otherwise used with other merchants included in the same hub as the merchant and/or in one or more different hubs), the total amount of money that has been spent with the particular merchant by various customers (which may, e.g., be evaluated by discount optimization and distribution computing platform 210 relative to the amount of money that has been spent with other merchants included in the same hub as the merchant and/or in one or more different hubs), the average distance traveled by customers of the particular merchant when redeeming a discount with the merchant and/or otherwise visiting the merchant's one or more business locations (which may, e.g., be evaluated by discount optimization and distribution computing platform 210 relative to the average distance traveled by customers for other merchants included in the same hub as the merchant and/or in one or more different hubs), the total number of times that various users have passed on relatively large discounts and/or special discounts that have been offered for the merchant (which may, e.g., be evaluated by discount optimization and distribution computing platform 210 relative to the number of times that users have passed on such discounts and/or discounts for other merchants included in the same hub as the merchant and/or in one or more different hubs), and/or user rating information that may be provided by customers of the merchant to discount optimization and distribution computing platform 210 (e.g., after such customers have redeemed a discount with the merchant and/or have otherwise visited the merchant's one or more business locations). Blackouts and/or knockouts, as discussed above, also may be included in and/or otherwise affect the one or more relative popularity factors in some instances. In addition, any and/or all of the information that may be used by discount optimization and distribution computing platform 210 in evaluating these and/or other factors may be obtained from one or more databases that are stored and/or maintained by discount optimization and distribution computing platform 210 and/or otherwise accessible to discount optimization and distribution computing platform 210. For example, at least some of the information that may be used by discount optimization and distribution computing platform 210 in evaluating these factors may be obtained from a database that stores, for each user of a user computing device, and for each discount used by each particular user, a discount amount offered by discount optimization and distribution computing platform 210 for use with a particular merchant, the day and/or time at which the user redeemed the discount, the amount of money that the user spent, the distance that the user traveled to get to the merchant's business location after accepting the discount, other discounts that the user chose not to use (e.g., the user's “skips” with respect to particular discounts that were offered to the user), and/or the user's rating of the merchant after redeeming the discount. Additional information and examples of how various discounts may be determined and how such an economic analysis may be performed are discussed in greater detail below.

At step 22, discount optimization and distribution computing platform 210 may communicate the discount information to user computing device 240. For example, at step 22, discount optimization and distribution computing platform 210 may send, via communication interface 216, to user computing device 240, discount information that includes one or more discounts for the user of user computing device 240. The one or more discounts that are provided by discount optimization and distribution computing platform 210 for the user of user computing device 240 may, for example, include at least one discount for each merchant of the at least two merchants included in the hub selected by the user of user computing device 240 at step 18. In addition, the one or more discounts may be determined (e.g., by discount optimization and distribution computing platform 210) based on an economic analysis using one or more factors, such as one or more user-specific preferences, use-specific factors, and/or one or more popularity factors.

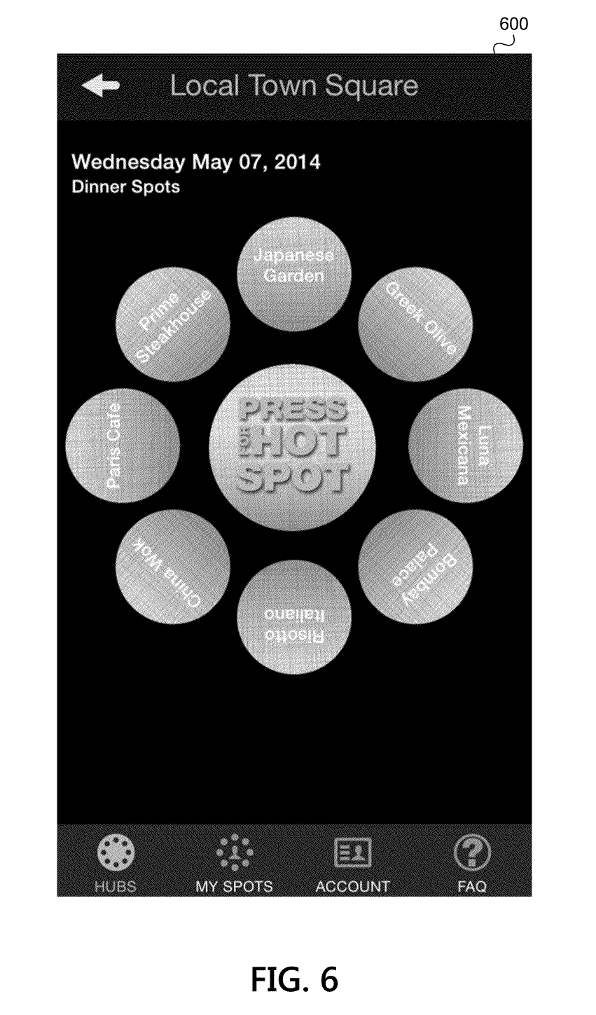

At step 23, user computing device 240 may receive the discount information provided by discount optimization and distribution computing platform 210. At step 24, user computing device 240 may present one or more discounts for the selected hub (e.g., based on the discount information received from discount optimization and distribution computing platform 210 at step 23). For instance, at step 24, user computing device 240 may present one or more discounts that include at least one discount for each merchant of the at least two merchants included in the selected hub. For example, user computing device 240 may generate, display, and/or otherwise present a graphical user interface similar to graphical user interface 600, depicted in FIG. 6, which may be configured to allow a user of user computing device 240 to select a discount of the one or more discounts. Additionally or alternatively, such a graphical user interface may be configured to allow a user of user computing device 240 to select an option for a randomized special discount (which may, e.g., be presented as a user-selectable button in the center of a ring of merchant names and/or other icons similar to the “Press for Hot Spot” button seen in FIG. 6).

Referring to FIG. 3F, at step 25, user computing device 240 may receive a request for a randomly-selected special discount. For example, at step 25, user computing device 240 may receive input from the user of user computing device 240 selecting an option for a randomized special discount (e.g., from a user interface presented by user computing device 240 at step 24). At step 26, user computing device 240 may request a randomized special discount from discount optimization and distribution computing platform 210.

At step 27, discount optimization and distribution computing platform 210 may receive the request for the randomized special discount. For example, at step 27, discount optimization and distribution computing platform 210 may receive, via communication interface 216, from user computing device 240, a request for a special discount for a user of user computing device 240. At step 28, discount optimization and distribution computing platform 210 may randomly select a merchant from the hub that was previously selected by the user of user computing device 240 (e.g., at step 18 above). For example, at step 28, in response to receiving the request for the special discount for the user of user computing device 240, discount optimization and distribution computing platform 210 may select, using a randomized process (e.g., a random number generation algorithm or the like), a merchant from the group of the at least two merchants (which may, e.g., form the hub that was previously selected by the user of user computing device 240). In addition, and as discussed above, the at least two merchants may be grouped (e.g., as a hub) based on the geographical proximity of corresponding business locations of the at least two merchants.

At step 29, discount optimization and distribution computing platform 210 may determine a big discount for the randomly selected merchant. For example, at step 29, discount optimization and distribution computing platform 210 may determine a big discount that is redeemable by the user of user computing device 240 with the randomly selected merchant. In some instances, discount optimization and distribution computing platform 210 may generate a special discount or “big” discount on the fly (e.g., upon receiving a request from a user computing device), while in other instances, such special discounts may be determined by discount optimization and distribution computing platform 210 in advance and stored for each merchant (e.g., when generating the one or more discounts for each hub, on a daily basis, etc.). In instances where special discounts are determined in advance, discount optimization and distribution computing platform 210 may simply retrieve stored information about a previously-generated special discount when determining a big discount at step 29.

In one or more embodiments, the big discount (which may, e.g., be determined by discount optimization and distribution computing platform 210 at step 29) may be determined based on one or more factors, similar to how the one or more initially determined discounts, which may also be referred to as “base discounts,” may be determined in the examples discussed above. For example, the big discount may be determined based on one or more factors including the current time of day, day of year (which may, e.g., include both the current day of the week and the specific day within the year it currently may be), current weather, and/or an amount of distance between an intended recipient of the big discount (e.g., the user of user computing device 240) and one or more business locations of the randomly selected merchant. Additionally or alternatively, the big discount (which may, e.g., be redeemable by the user of user computing device 240 with the randomly selected merchant) may provide a larger discount than a base discount of the one or more base discounts that is redeemable with the same merchant. In this way, the special discount, which may also be referred to as a “big discount,” may be determined by discount optimization and distribution computing platform 210 based on similar factors as the one or more base discounts, but the special discount may provide a greater discount for a specific merchant included in the hub than the base discount that may have been previously provided for that specific merchant. In addition, in randomly selecting merchants and/or determining special discounts for randomly selected merchants, discount optimization and distribution computing platform 210 may balance the amount and the extent of the special discounts that are offered for each merchant with the amount and the extent of the base discounts that are offered for each merchant, so that the base discounts and/or the special discounts that are offered for a particular merchant maximize profitability for the merchant by targeting the economic “sweet spot” (discussed above) at which point the predicted increase in demand generated by offering the base discounts and/or the special discounts outweighs the decrease in per-unit revenue resulting from each of the discounts provided by the base discounts and/or the special discounts. When maximizing revenue for a particular merchant, this may be called the unity point of the price elasticity of demand curve for the goods of a particular merchant (e.g., this point is where demand may transition from being price elastic to price inelastic). In some alternative embodiments, the base discounts might not be determined based on the same factors as the big discount; rather, the base discounts may be predetermined to provide a relatively low discount (e.g., five percent, ten percent, etc.), and only the big discount may be determined using the economic analysis discussed above.

At step 30, discount optimization and distribution computing platform 210 may communicate the determined big discount to user computing device 240. For example, at step 30, discount optimization and distribution computing platform 210 may send, via communication interface 216, to user computing device 240, discount information that defines and/or otherwise includes the big discount determined by discount optimization and distribution computing platform 210 at step 29 for the randomly selected merchant.

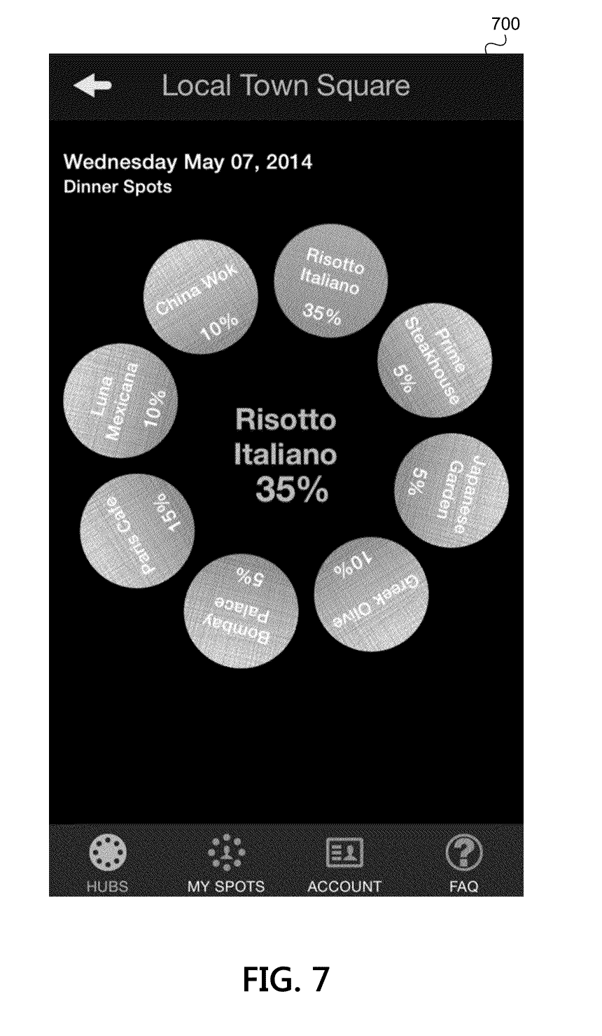

At step 31, user computing device 240 may receive the big discount from discount optimization and distribution computing platform 210. At step 32, user computing device 240 may present the big discount. For example, based on receiving the request for the randomly-selected special discount (e.g., at step 25), user computing device 240 may, at step 32, present a big discount that is redeemable with a randomly-selected merchant of the at least two merchants included in the hub. In presenting the big discount, user computing device 240 may generate, display, and/or otherwise present a graphical user interface similar to graphical user interface 700, depicted in FIG. 7, which may be configured to allow a user of user computing device to select the big discount (which may, e.g., be presented as a user-selectable button in the center of the ring similar to the “40%” discount button seen in FIG. 7). Additionally or alternatively, such a graphical user interface may be configured to allow a user of user computing device 240 to select a base discount of the one or more base discounts (which may, e.g., be presented as a ring of user-selectable buttons around the button corresponding to the big discount, as seen in FIG. 7). In instances in which the one or more base discounts are presented along with the big discount, a previously presented base discount for the randomly selected merchant (e.g., the merchant for which the big discount is presented) might no longer be displayed, as the relatively larger discount provided by the big discount may now be available to the user of user computing device 240 instead of the relatively smaller discount provided by the previously presented base discount for the merchant.

In some embodiments, after the big discount is determined (e.g., by discount optimization and distribution computing platform 210) and/or presented (e.g., by user computing device 240), a time limit may prevent the user of the user computing device from requesting a second randomly-selected special discount until a predetermined amount of time elapses after the big discount is determined and/or presented. For example, a particular user might only be able to receive one special discount per day, and if the user of user computing device 240 has already requested and received a randomized special discount on a given day, such a user may be prevented from requesting and/or receiving another randomized special discount until the next day.

In some embodiments, user computing device 240 might not display or otherwise present any discounts until the big discount is determined and/or presented (e.g., at step 32). In such arrangements, user computing device 240 might, for example, initially display a graphical user interface that is configured to receive a request for a randomized discount, and the base discounts discussed above might only be displayed and/or otherwise presented once and/or after the big discount is determined and/or presented (e.g., at step 32). For example, the base discounts may be presented by user computing device 240 in a graphical user interface along with the big discount (e.g., at step 32) and might not be presented prior to that point in time.

Referring to FIG. 3H, at step 33, user computing device 240 may receive a selection of a presented discount of one or more of the discounts that may be presented by user computing device 240. For example, at step 33, user computing device 240 may receive input from a user of user computing device 240 selecting one of the base discounts or the big discount presented in a graphical user interface provided by user computing device 240. At step 34, user computing device 240 may communicate discount selection information identifying the selected discount to discount optimization and distribution computing platform 210. For example, at step 34, user computing device 240 may communicate, via a communication interface included in user computing device 240, discount selection information identifying the discount selected by the user of user computing device 240.

At step 35, discount optimization and distribution computing platform 210 may receive the discount selection information from user computing device 240. For example, at step 35, discount optimization and distribution computing platform 210 may receive, via communication interface 216, from user computing device 240, discount selection information identifying a first discount selected by the user of user computing device 240. At step 36, discount optimization and distribution computing platform 210 may update relative popularity data based on the discount selection information. For example, at step 36, discount optimization and distribution computing platform 210 may update relative popularity data (which may, e.g., be stored in one or more databases that are stored and/or maintained by discount optimization and distribution computing platform 210 and/or otherwise accessible to discount optimization and distribution computing platform 210) for the merchant for which the user selected the discount and/or for the selected hub (which may, e.g., include the group of the at least two merchants) based on the discount selection information received from user computing device 240. As discussed above, the relative popularity data (which may, e.g., be updated at step 36 based on the discount selection information) may be used by discount optimization and distribution computing platform 210 in determining future base discounts and/or special discounts for the merchant and/or for one or more other merchants. In some alternative embodiments, the relative popularity data might not be updated (e.g., by discount optimization and distribution computing platform 210) until the discount is validated and/or redeemed with the merchant, as discussed below.

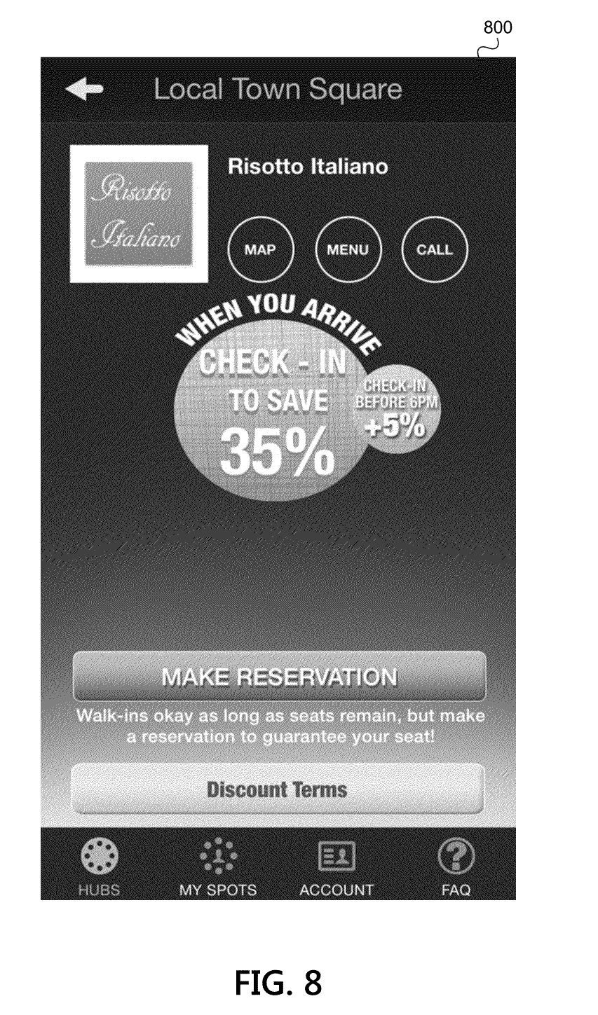

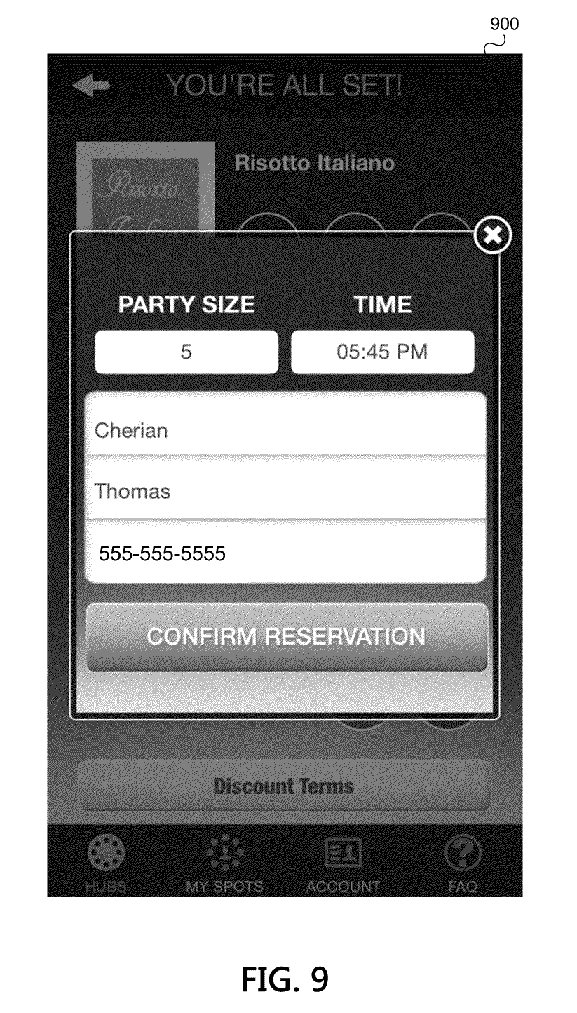

At step 37, user computing device 240 may receive reservation input from the user of user computing device 240. For example, at step 37, user computing device 240 may receive reservation input from the user of user computing device 240 via a graphical user interface presented by user computing device 240. In receiving such reservation input, user computing device 240 may generate, display, and/or otherwise present a graphical user interface similar to graphical user interface 800, depicted in FIG. 8, which may be configured to allow a user of user computing device 240 to create and/or modify a reservation with the merchant (which may, e.g., be a restaurant), enter one or more reservation details, and/or check-in at the merchant's business location (which may, e.g., enable the user of user computing device 240 to lock-in a time-based discount associated with the selected discount). Additionally or alternatively, in receiving reservation input, user computing device 240 may generate, display, and/or otherwise present a graphical user interface similar to graphical user interface 900, depicted in FIG. 9, which may be configured to allow a user of user computing device 240 to enter and/or edit one or more reservation details and/or confirm a reservation with the merchant associated with the discount selected by the user of user computing device 240.

Referring to FIG. 3I, at step 38, user computing device 240 may communicate reservation information to discount optimization and distribution computing platform 210. Such reservation information may, for example, include any and/or all of the reservation input received by user computing device 240 at step 37. At step 39, discount optimization and distribution computing platform 210 may receive the reservation information from user computing device 240, and at step 40, discount optimization and distribution computing platform 210 may store updated reservations data (which may, e.g., be stored and/or maintained by discount optimization and distribution computing platform 210) for one or more merchants based on the received reservation information. For example, at steps 39 and 40, discount optimization and distribution computing platform 210 may receive, via communication interface 216, from user computing device 240, reservation information that includes reservation details provided by the user of user computing device 240. The reservation details may, for example, be provided by the user of the user computing device for a first merchant associated with the first discount (i.e., the discount selected by the user of user computing device 240 at step 33 above). In some instances, the reservation details may include a reservation time, a party size, a username associated with the user of the user computing device, contact information associated with the user of the user computing device, and/or other information. In some embodiments, discount optimization and distribution computing platform 210 may be configured to allow one or more merchants to block out specific reservation times, so as to prevent one or more reservations from being made for such specific times by discount optimization and distribution computing platform 210 and/or by various users thereof (e.g., the user of user computing device 240). If, for example, the user of user computing device 240 attempts to make a reservation with a merchant during a time that has been blocked out by the merchant, discount optimization and distribution computing platform 210 may generate and send an error message to the user of user computing device 240, and the error message may instruct the user of user computing device 240 to make a reservation at another time. Additionally or alternatively, discount optimization and distribution computing platform 210 may communicate blackout information to user computing device 240, and such blackout information may identify one or more specific times where reservation(s) are not available with specific merchant(s), and user computing device 240 accordingly might not provide the user of user computing device 240 with the option of making a reservation during a blocked out time.

At step 41, discount optimization and distribution computing platform 210 may communicate merchant-specific reservations data to merchant computing device 250 (which may, e.g., be used by and/or otherwise associated with the merchant with which the user of user computing device 240 may redeem the previously-selected discount). For example, at step 41, discount optimization and distribution computing platform 210 may communicate, via communication interface 216, to a merchant computing device associated with the first merchant (e.g., merchant computing device 250), booking information that includes the reservation details associated with the reservation information received by discount optimization and distribution computing platform 210 at step 39. In instances in which the first merchant is a restaurant, the booking information provided by discount optimization and distribution computing platform 210 to merchant computing device 250 may, for example, include information identifying one or more reservation times; one or more corresponding party sizes; one or more corresponding names, usernames, and/or other identifiers; one or more corresponding pieces of contact information; and/or other information associated with one or more reservations maintained by discount optimization and distribution computing platform 210 for the merchant associated with merchant computing device 250.

At step 42, merchant computing device 250 may receive the merchant-specific reservations data from discount optimization and distribution computing platform 210. At step 43, merchant computing device 250 may present any and/or all of the merchant-specific reservations data received from discount optimization and distribution computing platform 210. In presenting the merchant-specific reservations data, merchant computing device 250 may, for example, present one or more graphical user interfaces that include the merchant-specific reservations data and/or other information about reservations that have been made with the merchant. Such graphical user interfaces may, for instance, be presented automatically (e.g., when the merchant-specific reservations data is received from discount optimization and distribution computing platform 210) and/or on-demand (e.g., when requested by a user of merchant computing device 250).

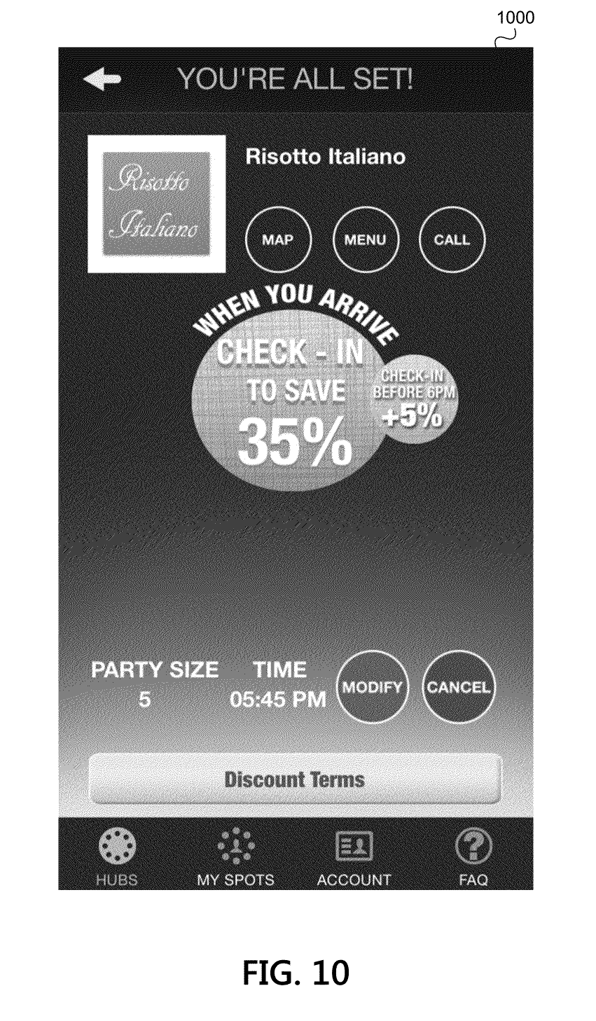

At step 44, user computing device 240 may receive a request to check-in at a location. For example, at step 44, user computing device 240 may receive a request to check-in at a current location of the user computing device 240, and such a request may be received as input from a user of user computing device 240. In some instances, the request to check-in at the current location of user computing device 240 may be received via a graphical user interface presented by user computing device 240. For example, in receiving such a request, user computing device 240 may present a graphical user interface similar to graphical user interface 1000, depicted in FIG. 10, which may be configured to allow a user of user computing device 240 to check-in at a merchant's business location. Such a request may, for example, be received after the user of user computing device 240 arrives at a business location operated by the first merchant with respect to which the user accepted a discount and/or made a reservation. In some instances, user computing device 240 may be configured to detect that it has arrived at the merchant's business location and may automatically present a push notification and/or a graphical user interface similar to the one discussed above that allows the user of user computing device 240 to check-in at the merchant's business location. As illustrated below, by requiring the user of user computing device 240 to check-in at the merchant's business location prior to redeeming the discount that was previously accepted by the user, the merchant and/or the organization operating discount optimization and distribution computing platform 210 can incentivize the user to visit the merchant's business location at or before a certain time (e.g., to lock in a time-based discount, a weather-based incentive discount, and/or any other type of incentive discount, such as the time-based bonus discount shown in FIG. 10 that provides an additional five-percent discount if the user checks in before 6 P.M.) and/or may ensure that discounts are only redeemed (and the merchant is only billed) in instances in which a discount has been actually and legitimately used at the merchant's business location at a particular and agreed-to time and date. Additionally or alternatively, by requiring the user of user computing device 240 to check-in at the merchant's business location upon arrival, discount optimization and distribution computing platform 210 may record, gather, and/or maintain information about the length of the user's visit to the merchant's business location and/or other locations, and this information may be used as a user-specific factor in determining discounts (e.g., users who are typically relatively quick visitors to participating merchants and/or relatively quick diners at participating restaurants may get larger discounts than users who are typically relatively slow visitors or diners at such merchants and/or restaurants).

Referring to FIG. 3J, at step 45, user computing device 240 may determine its current location. For example, at step 45, user computing device 240 may determine the current location of user computing device 240. In determining its current location, user computing device 240 may use various positioning techniques and/or location services built into user computing device 240, such as satellite-based positioning techniques (which may, e.g., enable user computing device 240 to determine its current position based on Global Positioning System (GPS) signals and/or other satellite signals received by one or more receivers included in user computing device 240), cellular-based positioning techniques (which may, e.g., enable user computing device 240 to determine its current position based on cellular signals received by one or more receivers included in user computing device 240), and/or other positioning techniques and/or location services (e.g., which may, e.g., enable user computing device 240 to determines its current position based on WLAN signals and/or other signals received by user computing device 240). Additionally or alternatively, in determining its current location, user computing device 240 may calculate and/or otherwise determine one or more geographic coordinates (e.g., latitude, longitude, etc.) that may represent the current location of user computing device 240.

At step 46, user computing device 240 may communicate check-in information to discount optimization and distribution computing platform 210. For example, at step 46, user computing device 240 may communicate check-in information identifying the current location of the user computing device 240 to facilitate redemption of the selected discount (e.g., the discount selected by the user at step 33 above). The check-in information may, for example, include location information obtained by one or more location services implemented by user computing device 240. For instance, the check-in information may include the one or more geographic coordinates determined by user computing device 240 as being representative of the current location of user computing device 240.

At step 47, discount optimization and distribution computing platform 210 may receive the check-in information from user computing device 240. For example, at step 47, discount optimization and distribution computing platform 210 may receive, via communication interface 216, from user computing device 240, check-in information identifying a current location of user computing device 240. At step 48, discount optimization and distribution computing platform 210 may validate the check-in information received from user computing device 240. In validating the check-in information, discount optimization and distribution computing platform 210 may determine whether and/or confirm that user computing device 240 is located at a business location associated with the merchant (e.g., the merchant with respect to which the user of user computing device 240 selected the discount, at step 33, and/or made a reservation, at step 37). By validating the check-in information in this way, discount optimization and distribution computing platform 210 may ensure that the merchant is only charged for discounts that are not only actually redeemed but also redeemed at the agreed on time, place, and/or other terms and conditions associated with the discount (e.g., at a specific business location operated by the merchant among a plurality of business locations that may be operated by the merchant).

If discount optimization and distribution computing platform 210 determines that the check-in information received from user computing device 240 is invalid (e.g., at step 48), then at step 49, discount optimization and distribution computing platform 210 may generate an error message, and at step 50, discount optimization and distribution computing platform 210 may send the generated error message to user computing device 240. Alternatively, if discount optimization and distribution computing platform 210 determines that the check-in information received from user computing device 240 is valid (e.g., at step 48), then at step 51a, discount optimization and distribution computing platform 210 may generate a request for a merchant redemption code, and at step 51b, discount optimization and distribution computing platform 210 may request the merchant redemption code from user computing device 240. For example, at steps 51a and 51b, based on validating the check-in information received from user computing device 240, discount optimization and distribution computing platform 210 may request, via communication interface 216, from user computing device 240, a merchant redemption code. The merchant redemption code may, for example, be a unique code assigned to the merchant by discount optimization and distribution computing platform 210 and/or by an entity operating discount optimization and distribution computing platform 210, and as illustrated below, the merchant redemption code may be used in verifying that the merchant has acknowledged, is redeeming, and/or will redeem the discount associated with the discount previously selected by the user of user computing device 240.

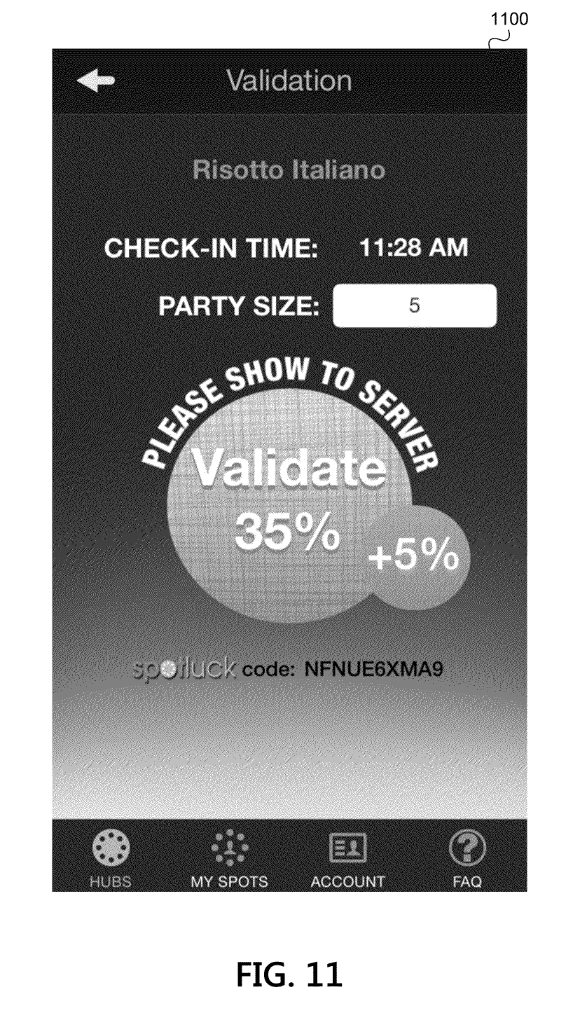

At step 52, user computing device 240 may receive the request for the merchant redemption code from discount optimization and distribution computing platform 210. At step 53, user computing device 240 may prompt the user of user computing device 240 to provide a merchant redemption code. The prompt may, for example, instruct the user of user computing device 240 to hand over the user computing device 240 to an employee of the merchant at the business location to facilitate entry of the merchant redemption code. Additionally or alternatively, the prompt may, for example, instruct the user of user computing device 240 to scan a barcode, quick response (QR) code, and/or other image which may be present at the merchant's business location and which may serve as the merchant's merchant redemption code. In some instances, in prompting the user of user computing device 240 to provide the merchant redemption code, user computing device 240 may present a graphical user interface similar to graphical user interface 1100, depicted in FIG. 11, which may be configured to instruct the user of user computing device 240 to show the graphical user interface and/or the user computing device 240 to an employee of the merchant at the business location (who may, e.g., be a server in instances where the merchant is a restaurant). As seen in FIG. 11, such a graphical user interface may include a user-selectable button (e.g., a “Validate” button) that, when selected, may cause user computing device 240 to present a text entry field in which the merchant redemption code can be entered (e.g., by the employee of the merchant at the business location who may be handed the user computing device 240 by the user of user computing device 240).

Referring to FIG. 3L, at step 54, user computing device 240 may receive merchant code input (e.g., from the employee of the merchant at the business location who may be handed the user computing device 240 by the user of user computing device 240). Such merchant code input may, for example, include the merchant redemption code provided to the merchant by an entity operating discount optimization and distribution computing platform 210. Additionally or alternatively, the merchant code input may be received by user computing device 240 via one or more graphical user interfaces presented by user computing device 240. At step 55, user computing device 240 may communicate redemption information to discount optimization and distribution computing platform 210, and the redemption information may include any and/or all of the merchant code input received by user computing device 240.

At step 56, discount optimization and distribution computing platform 210 may receive the redemption information from user computing device 240. For example, at step 56, discount optimization and distribution computing platform 210 may receive, via communication interface 216, from user computing device 240, redemption information that includes merchant code input. At step 57, discount optimization and distribution computing platform 210 may validate the redemption information received from user computing device 240. In validating the redemption information, discount optimization and distribution computing platform 210 may, for example, determine whether and/or confirm that the merchant code input matches the predefined merchant redemption code for the particular merchant, that the party size entered by the merchant matches the party size associated with the reservation, and/or that the reservation details otherwise match with corresponding information included in and/or provided with the redemption information.

If discount optimization and distribution computing platform 210 determines that the redemption information received from user computing device 240 is invalid (e.g., at step 57), then at step 58, discount optimization and distribution computing platform 210 may generate an error message, and at step 59, discount optimization and distribution computing platform 210 may send the generated error message to user computing device 240. Alternatively, if discount optimization and distribution computing platform 210 determines that the redemption information received from user computing device 240 is valid (e.g., at step 57), then at step 60, discount optimization and distribution computing platform 210 may mark the discount associated with the redemption information (which may be the discount selected by the user of user computing device 240 at step 33) as redeemed (which may, e.g., prevent the discount from being used again).

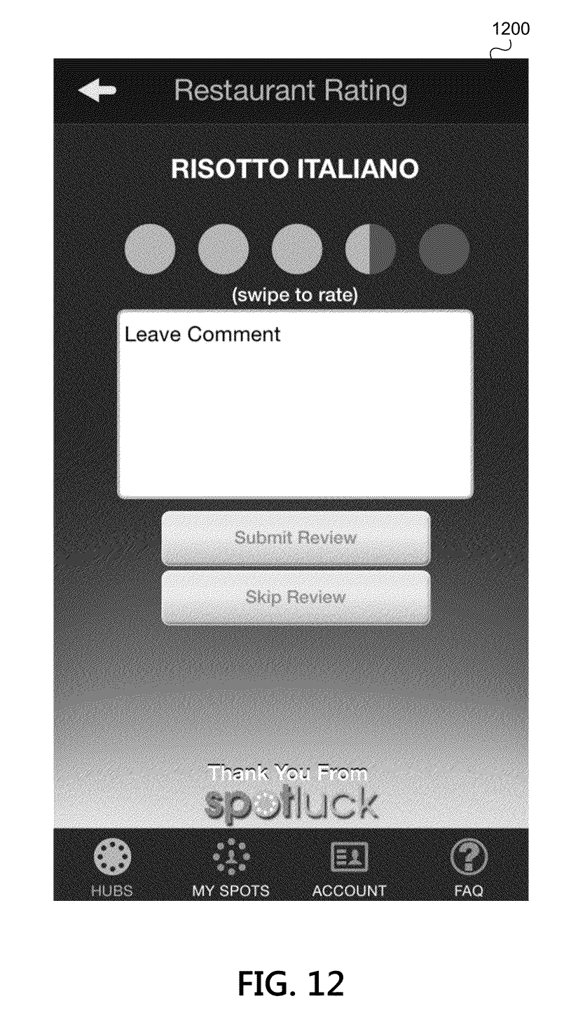

At step 61, discount optimization and distribution computing platform 210 may communicate redemption confirmation information to user computing device 240. The redemption confirmation information may indicate that the redemption information provided by user computing device 240 to discount optimization and distribution computing platform 210 has been validated and/or that the user of user computing device 240 has received a discount associated with the previously-selected discount. In some instances, upon receiving the redemption confirmation information from discount optimization and distribution computing platform 210, user computing device 240 may prompt the user of user computing device 240 to provide feedback on the merchant with which the discount has been redeemed. In prompting the user of user computing device 240 to provide such feedback, user computing device 240 may generate, display, and/or otherwise present a graphical user interface similar to graphical user interface 1200, depicted in FIG. 12, which may be configured to allow a user of user computing device 240 to provide a rating for a merchant and/or submit a review of the merchant. Any and/or all of the information provided by the user of user computing device 240 via such a user interface may be provided by user computing device 240 to discount optimization and distribution computing platform 210. Such information may, for example, be shared with others who may receive discounts from discount optimization and distribution computing platform 210 and/or may be used by discount optimization and distribution computing platform 210 in determining future discounts for the merchant and/or other merchants included in the same hub as the merchant.

Referring to FIG. 3N, at step 62, discount optimization and distribution computing platform 210 may update billing information for the merchant linked to the validated merchant redemption code. For example, at step 62, based on validating the redemption information (e.g., at step 57), discount optimization and distribution computing platform 210 may update billing information for the merchant that is linked to and/or otherwise associated with the merchant redemption code that was validated by discount optimization and distribution computing platform 210 (e.g., at step 57). For instance, an entity operating discount optimization and distribution computing platform 210 may charge a fee for each discount that is provided by discount optimization and distribution computing platform 210 to a potential customer on behalf of each merchant and/or each discount that is subsequently redeemed. By updating billing information in this way, discount optimization and distribution computing platform 210 may ensure that records of the entity operating discount optimization and distribution computing platform 210 accurately reflect usage of the service(s) provided by discount optimization and distribution computing platform 210 and/or by the entity operating discount optimization and distribution computing platform 210.

At step 63, discount optimization and distribution computing platform 210 may update usage records for the user of user computing device 240 based on validating the redemption information. Such usage records may, for instance, be subsequently used by discount optimization and distribution computing platform 210 in generating future discounts for the user of user computing device 240. At step 64, discount optimization and distribution computing platform 210 may update one or more records for the merchant associated with the validated merchant redemption code and/or one or more records for the hub associated with the merchant (e.g., relative popularity data). Such records may, for instance, be subsequently used by discount optimization and distribution computing platform 210 in generating future discounts for the user of user computing device 240. At step 65, discount optimization and distribution computing platform 210 may determine one or more updated discounts, such as one or more updated base discounts and/or one or more updated special discounts. The one or more updated discounts may, for example, be determined by discount optimization and distribution computing platform 210 similar to how the discounts may be initially determined by discount optimization and distribution computing platform 210 at step 5 (e.g., based on weather, blackouts, skips, etc.), except that the new and/or updated information generated during the redemption and/or validation of the redemption information discussed above may be taken into account by discount optimization and distribution computing platform 210 in determining the one or more updated discounts. For example, at step 65, discount optimization and distribution computing platform 210 may determine at least one discount based on updated information, which may include updated relative popularity data, for the group of the at least two merchants (which may, e.g., include the first merchant for which the discount selected by the user of user computing device 240 was redeemed and validated). The one or more discounts determined by discount optimization and distribution computing platform 210 based on such updated information may, for example, include one or more discounts determined for the same user (e.g., the user of user computing device 240) on a different day (e.g., the next day) and/or may include one or more discounts determined for a different user on the same day or on a different, future day.

At step 66, administrative computing device 225 may receive a request for a billing report. Such a request may, for example, be received from a user of administrative computing device 225 and may identify one or more merchants for which billing information should be included in the billing report. In addition, the billing report may enable an entity operating discount optimization and distribution computing platform 210 to process and/or otherwise handle billing of various merchants for offering, providing, redeeming, and/or otherwise managing various discounts and discounts on their behalf.

At step 67, administrative computing device 225 may request billing information from discount optimization and distribution computing platform 210 based on the request for the billing report received at step 66 (e.g., based on the one or more merchants identified in the request for the billing report). At step 68, discount optimization and distribution computing platform 210 may receive the request for the billing information. The request may, for example, include information identifying one or more merchants for which billing information is requested. At step 69, discount optimization and distribution computing platform 210 may retrieve records for the one or more merchants identified in the request for billing information. Any and/or all of these records may be stored in one or more databases that are stored and/or maintained by discount optimization and distribution computing platform 210 and/or that are otherwise accessible to discount optimization and distribution computing platform 210. At step 70, discount optimization and distribution computing platform 210 may communicate billing information that includes any and/or all of the retrieved records to administrative computing device 225.

At step 71, administrative computing device 225 may receive the billing information from discount optimization and distribution computing platform 210. At step 72, administrative computing device 225 may generate a billing report based on the received billing information. The billing report may, for example, include information about the discounts that have been offered and/or redeemed for one or more particular merchants, the dates and/or times such discounts were offered and/or redeemed, and/or other information associated with the discounts that have been offered and/or redeemed. At step 73, administrative computing device may present the billing report (e.g., via one or more graphical user interfaces that may be generated, displayed, and/or otherwise presented by administrative computing device 225). At step 74, administrative computing device 225 may communicate a merchant-specific billing summary to merchant computing device 250. The merchant-specific billing summary may, for example, include billing information for the merchant that is linked to and/or otherwise associated with merchant computing device 250 (e.g., and might not billing information for one or more other merchants). At step 75, merchant computing device 250 may receive and present the billing summary. For example, at step 75, merchant computing device 250 may present via one or more graphical user interfaces any and/or all of the billing summary received from administrative computing device 225 to facilitate processing and/or payment.

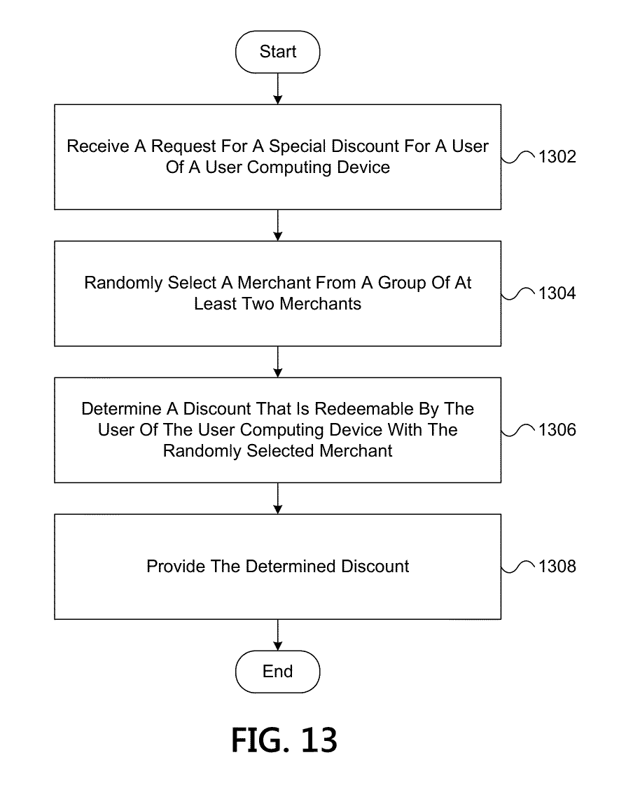

FIG. 13 depicts an example of a method of optimizing and distributing discounts in accordance with one or more illustrative aspects of the disclosure. Referring to FIG. 13, at step 1302, a computing platform may receive a request for a special discount for a user of a user computing device. For example, at step 1302, discount optimization and distribution computing platform 210 may receive a request for a special discount for a user of user computing device 240. At step 1304, in response to receiving the request for the special discount for the user of the user computing device, the computing platform may randomly select a merchant from a group of at least two merchants, and the at least two merchants may be grouped based on geographical proximity of corresponding business locations of the at least two merchants. For example, at step 1304, discount optimization and distribution computing platform 210 may select, using a randomized process (e.g., a random number generation algorithm), a merchant from such a group of at least two merchants. At step 1306, the computing platform may determine a big discount that is redeemable by the user of the user computing device with the randomly selected merchant. For example, at step 1306, discount optimization and distribution computing platform 210 may determine such a big discount. At step 1308, the computing platform may communicate the big discount to the user computing device. For example, at step 1308, discount optimization and distribution computing platform 210 may communicate the determined discount to user computing device 240.

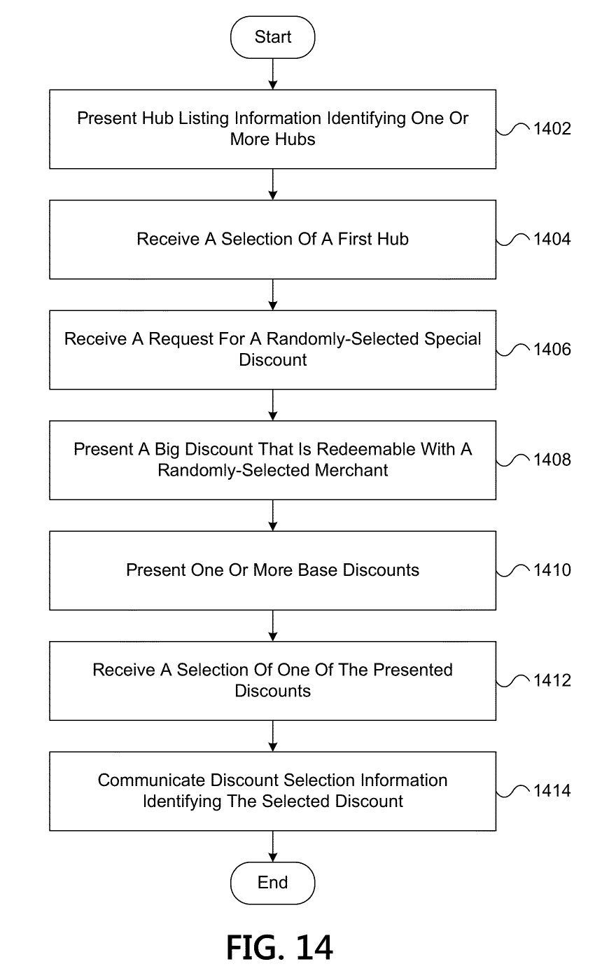

FIG. 14 depicts another example of a method of optimizing and distributing discounts in accordance with one or more illustrative aspects of the disclosure. Referring to FIG. 14, at step 1402, a user computing device may present hub listing information identifying one or more hubs. For example, at step 1402, user computing device 240 may present hub listing identifying one or more hubs. At step 1404, the user computing device may receive a selection of a first hub of the one or more hubs. The first hub may include a group of at least two merchants, and the at least two merchants may be grouped into the first hub based on geographical proximity of corresponding business locations of the at least two merchants. For example, at step 1404, user computing device 240 may receive a selection of such a hub. At step 1406, the user computing device may receive a request for a randomly-selected special discount. For example, at step 1406, user computing device 240 may receive such a request. At step 1408, based on receiving the request for the randomly-selected special discount, the user computing device may present a big discount that is redeemable with a randomly-selected merchant of the at least two merchants. For example, at step 1408, user computing device 240 may present such a big discount. At step 1410, the user computing device may present one or more base discounts, and the one or more base discounts include at least one base discount for each merchant of the at least two merchants other than the randomly-selected merchant. For example, at step 1410, user computing device 240 may present such base discounts. At step 1412, the user computing device may receive a selection of one of the presented discounts. For example, at step 1412, user computing device 240 may receive such a selection. At step 1414, the user computing device may communicate, via a communication interface included in and/or otherwise associated with the user computing device, discount selection information identifying the selected discount. For example, at step 1414, user computing device 240 may communicate such discount selection information.

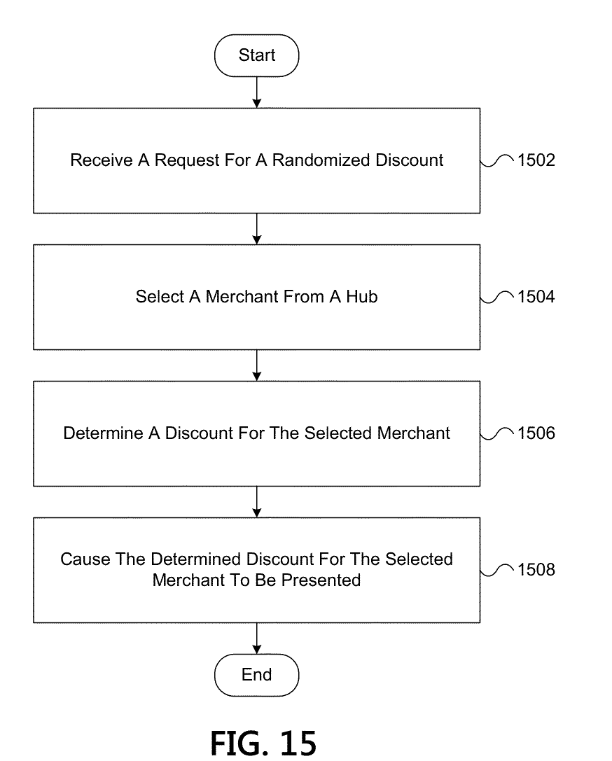

FIG. 15 depicts another example of a method of optimizing and distributing discounts in accordance with one or more illustrative aspects of the disclosure. At step 1502, a computing device, such as generic computing device 100, may receive a request for a randomized discount. At step 1504, in response to receiving the request for the randomized discount, the computing device may select a merchant from a hub, and the hub may include at least two merchants grouped based on geographical proximity of business locations of the at least two merchants. At step 1506, the computing device may determine a discount for the selected merchant. At step 1508, the computing device may cause the determined discount for the selected merchant to be presented.

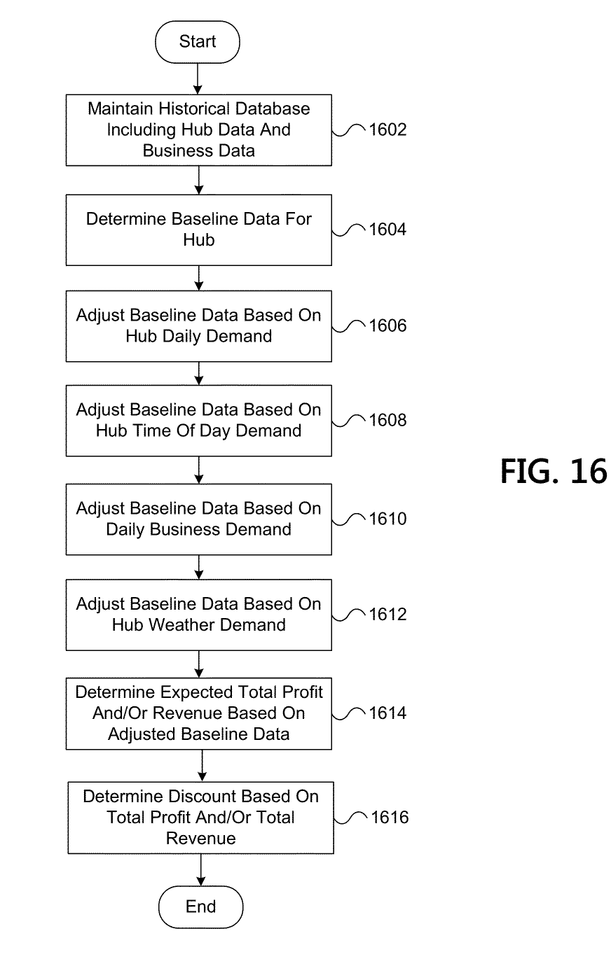

As discussed above, various aspects described herein relate to the optimization and distribution of discounts to users. Also discussed above, various aspects described herein relate to organizing businesses into hubs so that the discounts can, for example, be optimized for a hyper-local group of businesses. There are various ways in which discounts can be optimized and distributed for businesses of the hubs described above. FIG. 16 depicts one such example method. In particular, FIG. 16 depicts an example method of determining discounts based on hub and business data. In some arrangements, the method of FIG. 16 may be performed by discount optimization and distribution computing platform 210 of FIG. 2, or any other suitable computing device or platform.

At step 1602, a computing platform may maintain a historical database that includes hub data and business data. In general, the historical database may store information describing a history of the hubs, businesses and the users' usage of the discount services at various levels of granularity. Such information may be organized, for example, by hub, by business, by time of day, by day of the year, and the like.

In some embodiments, the historical database may be updated or otherwise maintained as the various computing devices depicted in FIGS. 3A-3Q and 13-15 provide the discount services. The hub data and business data may include any of the types of data discussed above including hub listing information, knockout data, the number of skips on special or big discounts, and the like. With respect to FIGS. 3A-3Q, the historical database may be maintained by storing to or updating information in the historical database from time to time, such as at steps 3, 36, 39, 40, 47, 48, 56, 60 and 62-64 of FIGS. 3A-3Q. These and other types of data that may be stored by the historical database may be apparent from the detailed example provided by the remaining steps of FIG. 16.

As information is updated in the historical database, a self-sustaining ecosystem may be provided (e.g., by discount optimization and distribution computing platform 210, by one or more other elements of computing environment 200, etc.) as various different users accept and/or redeem discounts with various different merchants over time. In particular, as more data is gathered about particular users, particular merchants, and/or discounts that have been accepted and/or redeemed (e.g., over the course of weeks, months, years, etc.), any and/or all of this data may be used in determining, offering, and/or otherwise providing future discounts to various users for redemption with various merchants with minimal or no administrative user interaction.

The historical database may include data derived from the information stored to the historical database. The types of data, statistic or otherwise, that can be derived and used to enrich the historical database may be dependent on the types of data the historical database stores. For example, the historical database may include running averages, medians, modes, or other statistic data. As one particular example, the database may include running averages for the number of people that completed a transaction at the business (e.g., redeemed a discount, checked-in at the business location, etc.). The running averages may be the average redemption rate for various levels of discounts (e.g., a running average for each discount offered by the discount service for that hub). These and other types of derived data that can be stored in the historical database may be apparent from the detailed example of the remaining steps of FIG. 16.

The historical database may store weather data for a hub, such as a record of the types of weather experienced at a geographic region associated with the hub. For example, the weather data may be input for each hub via the admin computing device 225 on a daily basis. As another example, each hub may be associated with a zip code and a script may be created that retrieves weather information for the zip code from a weather service or website each hour or day. The retrieved weather information may be categorized into a type of weather (fair, bad or severe) and the category may be stored in the historical database. These and other types of weather data that may be stored by the historical database may be apparent from the detailed example provided by the remaining steps of FIG. 16.

The historical database may store data from other sources. For example, the historical database may store data retrieved via third-party sources. Examples of third party sources may include, for example, a source for traffic data, a source for parking garage data, a source for metro stall information, and one or more sources for business rating website data (e.g., websites that allows users to rate and/or provide opinions based on an experience at a business).

For ease of illustration, many of the remaining steps of FIG. 16 will be discussed in terms of determining discounts for a restaurant. A restaurant is chosen for this example only for illustrative purposes and, in fact, is just one of the many types of businesses for which discounts may be determined using the method depicted in FIG. 16. In some embodiments, steps 1604-1616 may be performed by discount optimization and distribution computing platform 210 of FIG. 2 when, for example, platform 210 determines a discount at step 29 of FIG. 3G.

Additionally, before the remaining steps of FIG. 16 are described in detail, a brief summary may be beneficial to understanding a generalized example of determining discounts according to the aspects described herein. Steps 1604-1612 relate to determining an expected diner model that may then be used to determine a discount for a restaurant. The discount, once determined, may be offered to and redeemed by a user (e.g., via user computing device 240 of FIG. 2). To summarize the steps of 1604-1612, the expected diner model may first be initialized at step 1604 with baseline data of a hub that the restaurant belongs to, which in some embodiments may be retrieved from the historical database maintained at step 1602. Any of the data stored by the historical database may indicate demand for a hub or restaurant in a given scenario and/or may be used to determine a demand model for a hub or restaurant in a given scenario. The baseline data may then be adjusted based on one or more demand factors, as illustrated by steps 1606-1612. Each of the one or more demand factors may be applied a weight so that certain factors influence the expected diner model more than others. The data needed to determine the one or more demand factors may be retrieved from the historical database.

The example embodiment illustrated by FIG. 16 depicts an example where an initial expected diner model is adjusted by 4 demand factors: hub daily demand, hub time of day demand, business demand, and hub weather demand. Adjusting for each demand factor may add or subtract expected diners from the expected diner model. The 4 factors are chosen for illustrative purposes and other embodiments may adjust the initial expected diner model using more or less factors. Other examples of factors include, but are not limited to: a duration of discount factor (e.g., a shorter duration discount may indicate the expected diner model should be decreased); user preference factors (e.g., a user has indicated a preference for a type of food, such as, Italian, may cause an increase in the expected diner model if the restaurant is also an Italian restaurant); hub reward factors (e.g., the restaurants of a hub may compete against each other during a time period, such as a competition for the most number of discount redemptions over a given week, then the expected diner demand model may be adjusted so that the discount for the winning restaurant is increased); current event factors (e.g., occurrence of a concert or festival in the vicinity of the hub may cause an increase or decrease in the expected diner model); web presence factors (e.g., the number of hits at a restaurant's website may indicate the expected diner model should be increased or decreased); user loyalty factors (e.g., if the user has repeatedly ate at a restaurant or a hub, then the expected diner model may be increased); and user participation factors (e.g., if a merchant has submitted a rating of a user via the discount services, then when determining discounts for that user the expected diner model may be increased or decreased based on the rating; if the user has clicked on links to share, via a social network, the discount services, then the expected diner model may be increased when determining discounts for that user; and if the user uses a loyalty currency provided by the discount services, then the expected diner model may be increased). Of course, when determining discounts for other types of businesses, additional types of factors may be used in addition to those described above. For example, if determining a discount for a retailer (e.g., a department store), an inventory factor may be used (e.g., if the retailer has a limited inventory, then the demand model may be adjusted such that a lower discount is determined; if the retailer has a surplus of inventory, then the demand model may be adjusted such that a higher discount is determined). In general, many or all of the types of data stored by the historical database may be used as a demand factor or used to derive a demand factor.

Additionally, the types of factors chosen may be dynamic or based on recent activities of the hub, users, or restaurants. For example, if a user attempted to make a reservation at a certain restaurant via the discount services, but was unable to successfully make the reservation, than certain factors may be ignored/not used when determining a discount for that user (e.g., user preference factors may be ignored when adjusting the expected diner model) and in some embodiments, other demand factors may be used in place of the ignored/not used demand factors (e.g., user loyalty factors may be used in place of the user preference factors).

The initialization and adjustment process depicted in step 1604-1612 may be generalized by the following equation:

M_{adj}=Mᵢₙᵢₜ(ω₁f₁+ω₂f₂+ . . . +ωₙfₙ)

Where M_{adj} is the adjusted model, Mᵢₙᵢₜ is the initial model, f is a demand factor, and ωₙ is the weight for the n^{th} demand factor. In some arrangements, each weight may be equal to or based on a standard deviation determined for each factor. Each weight may be set according to a factor priority (e.g., certain factors may be selected to influence the demand model to a greater degree than others). For example, the hub daily demand factor may be weighted by a value twice as large as the hub weather demand factor (e.g., hub daily demand factor may be set to 2, while the hub weather demand factor is set to 1).

After completing the adjustment process (steps 1606-1612), the adjusted model may be used to determine an expected total profit and/or expected total revenue for the restaurant (step 1614) and the expected total profit and/or expected total revenue may be used to determine the discount (step 1616). Additional details of steps 1604-1616 will now be discussed.

At step 1604, the computing platform may determine baseline data for a hub. In this illustrative example, the discount that is to be determined may be for a restaurant (e.g., Risotto Italiano of FIG. 6) that belongs to a particular hub (e.g., the hub that includes the restaurants depicted in FIG. 6). The baseline data may be retrieved from the historical database and/or may be derived from data retrieved from the historical database. For example, the historical database may be queried for data about the hub and such queries may return information describing how many diners on average ate at the restaurant at various discount levels, information describing the average profit level at the various discount levels, and information describing the average discounted price at the various discount levels. Of course, the baseline data may, in some embodiments, need to be determined based on the information the historical database returns (e.g., determine the average numbers of diners according to data retrieved from the historical database).

The following table provides an example of the baseline data for a hub of restaurants.

TABLE 1
Example Baseline Data

| | Average | Average | |
|---|---|---|---|
| Discount | Discount | Discount | Average |
| Level | Price | Profit | Diners |
| 0% | $20.00 | $14.00 | 80 |
| 5% | $19.00 | $13.00 | 100 |
| 10% | $18.00 | $12.00 | 120 |
| 15% | $17.00 | $11.00 | 140 |
| 20% | $16.00 | $10.00 | 160 |
| 25% | $15.00 | $9.00 | 180 |
| 30% | $14.00 | $8.00 | 200 |
| 35% | $13.00 | $7.00 | 220 |
| 40% | $12.00 | $6.00 | 230 |
| 45% | $11.00 | $5.00 | 240 |
| 50% | $10.00 | $4.00 | 255 |
| 55% | $9.00 | $3.00 | 260 |
| 60% | $8.00 | $2.00 | 265 |
| 65% | $7.00 | $1.00 | 270 |
| 70% | $6.00 | $ — | 265 |
| 75% | $5.00 | $(1.00) | 260 |

At step 1606, the computing platform may adjust the baseline data based on a hub daily demand factor. In some embodiments, the hub daily demand factor may be based on the hub's cumulative number of diners for a particular day of the week, based on the hub's discount redemption rate during a particular day of the week, or based on the number of times a special discount was requested for the hub on the particular day of the week. Indeed, the discount to be determined may be redeemable by a user on the current day. In such embodiments, the hub daily demand factor may be the z-score (also referred to as the standard score) for the current day calculated (or otherwise determined) based on information retrieved from the historical database.

For example, the hub daily demand factor may be the z-score for the current day determined according to the number of diners that ate at the restaurant's hub during the current day. In another example, the hub daily demand factor may be the z-score for the current day determined according to the number of times a special discount was requested for the hub (e.g., requested via a press of the button for a “Hot Spot” discount as illustrated in FIG. 6) during the current day. In yet another example, the hub daily demand factor may be the z-score for the current day determined according to the number of users that redeemed a discount during the current day. The number of users that redeemed a discount may further be conditioned on the number of users active with the discount services (also referred interchangeably as “active users”). Active users may be the users that, for example, requested a special discount deal by pressing the “Press for Hot Spot” button of FIG. 6 for the hub in question or were otherwise active with the discount services. In yet another example, the hub daily demand factor may be the z-score for the current day determined according to the redemption rate of active users during the current day. The following table provides example z-scores determined according to the redemption rate of active users and, in some embodiments may be used as the hub daily demand factor. As seen in Table 2, determining the z-score may include determining a standard deviation of the redemption rate.

TABLE 2
Example Z-Scores for Hub Daily Demand Factor

| | Redemption Rate (as | | |
|---|---|---|---|
| DAY | percent of active users) | Z Score | |
| Monday | 0.50% | −0.8 | |
| Tuesday | 0.50% | −0.8 | |
| Wednesday | 0.50% | −0.8 | |
| Thursday | 1.00% | −0.1 | |
| Friday | 2.00% | 1.4 | |
| Saturday | 2.00% | 1.4 | |
| Sunday | 1.00% | −0.1 | |
| AVERAGE | 1.071% | ST DEV | 0.006726 |

After determining the hub daily demand factor for the current day (e.g, if the current day is Monday, the hub daily demand factor may be −0.8 per Table 2), the hub daily demand factor may be multiplied by the weight assigned to the hub daily demand factor. In some arrangements, the weights may be equal to or based on the standard deviation determined for the demand factor. For example, with respect to the example illustrated in Table 2, because the redemption rate is a percentage, the weight may be assigned 67.26 (based on the standard deviation of 0.006726). Accordingly, the result of multiplying the hub daily demand factor (e.g., −0.8) and the assigned weight (e.g., 67.26) may be used to adjust the baseline data (e.g., add the result to the number of average diners at the various discount levels). In this example, because the z-score chosen for the hub daily demand factor is negative, the baseline data may be adjusted down (e.g., by 54 diners).

The above description of steps 1604 and 1606 illustrate an example embodiment where the baseline data for the demand model includes a number of average diners for a hub at various discount levels, which may then be adjusted based on a demand factor that is weighted based on a standard deviation. The demand model may be based on different types of baseline data. For example, alternative embodiments may determine the baseline data for a demand model that includes a redemption rate for a hub at various discount levels.

Additionally, different types of baseline data may cause the weights to be assigned differently. For example, as described above, the hub daily demand factor (e.g., z-score of −0.8) may be multiplied by a weight that is based on a standard deviation (e.g., a weight of 67.26, which is based on the standard deviation of 0.006726). This conversion of the standard deviation (0.006726) to the weight (67.26) may be dependent on the baseline data being of a different type from the demand factor (e.g., baseline data being of an expected diner type and the hub daily demand factor being of a redemption rate type). If the baseline data and the demand factor were of the same type (e.g., baseline data and the hub daily demand factor both being of a redemption rate type), some embodiments may set the weight to be equal to the standard deviation (e.g., set the weight to 0.006726).

At step 1608, the computing platform may adjust the baseline data based on a hub time of day demand factor. In some embodiments, the hub time of day demand factor may be based on the hub's cumulative number of diners during a particular interval of time, based on the hub's discount redemption rate during a particular interval of time, or based on the number of successful check-ins at restaurants of the hub during a particular interval of time. Indeed, the discount to be determined may be expected to be redeemed at or by a particular time of day (e.g., the user may be required to check into the restaurant by a particular time). In such embodiments, the hub time of day demand factor may be the z-score for the particular time of day (or an interval of time based on the particular time of day) and the z-score may be determined based on information retrieved from the historical database.

For example, the hub time of day demand factor may be the z-score for the particular time of day determined according to the number of diners at the restaurant's hub during the particular time of day. In another example, the hub time of day demand factor may be the z-score for the particular time of day determined according to the number of active users that redeemed a discount during the particular time of day. In yet another example, the hub time of day demand factor may be the z-score for the particular time of day determined according to the redemption rate of active users during the particular time of day. The following table provides example z-scores determined according to the redemption rate of active users and, in some embodiments, may be used as the hub time of day demand factor. As seen in Table 3, determining the z-score may include determining a standard deviation of the redemption rate.

TABLE 3
Example Z-Scores For Hub Time Of Day Demand Factor

| | Redemption Rate (as | | |
|---|---|---|---|
| DAY | percent of active users) | Z Score | |
| 6:00 AM-7:59 AM | 0.00% | −1.0 | |
| 8:00 AM-10:59 AM | 0.10% | −0.9 | |
| 11:00 AM-1:59 PM | 0.30% | −0.8 | |
| 2:00 PM-4:59 PM | 2.00% | 0.3 | |
| 5:00 PM-7:59 PM | 4.00% | 1.6 | |
| 8:00 PM-10:59 PM | 3.00% | 1.0 | |
| 11:00 PM-1:59 AM | 1.00% | −0.3 | |
| AVERAGE | 1.486% | ST DEV | 0.015625 |

After determining the hub time of day demand factor for the particular time of day (e.g, if the particular time of day is 5:00 PM-7:59 PM, the hub time of day demand factor may be 1.6 per Table 3), the hub time of day demand factor may be multiplied by the weight assigned to the hub time of day demand factor. In some arrangements, the weights may be equal to or based on the standard deviation determined for the demand factor. For example, with respect to the example illustrated in Table 3, because the redemption rate is in a percentage, the weight may be assigned 15.63 (based on the standard deviation of 0.015625 and in consideration that time of day redemption rates may have a large standard deviation for restaurants). Accordingly, the result of multiplying the hub time of day demand factor (e.g., 1.6) and the assigned weight (e.g., 15.63) may be used to adjust the baseline data (e.g., add the result to the number of average diners at the various discount levels). In this example, because the z-score chosen for the hub time of day demand factor is positive, the baseline data may be adjusted up (e.g., by 25 diners).

At step 1610, the computing platform may adjust the baseline data based on a business demand factor. In some embodiments, the business demand factor may be determined based on the relative popularity of the restaurant versus the popularity of the other restaurants of the hub (e.g., the number of times diners ate at Risotto Italiano with respect to the other restaurants of the hub, as depicted in FIG. 7). The other embodiments, the business demand factor may based on the number of diners that ate a style of food served by the restaurant during a particular day (e.g., number of users that ate Italian food). The business demand factor may be based on a number of “Hot Spot” discounts (e.g., the 35% deal for Risotto Italiano of FIG. 7) that were offered to the users but not selected by the users of the discount services (e.g., the user selects one of the discounts for the remaining restaurants of FIG. 7) during a particular day, week or month. In accordance with the above discussion of FIGS. 3A-3Q, “Hot Spot” discounts are also referred herein as “special discounts” or “big discounts” and the discount selected by the user is also referred herein as a “selected discount.” The business demand factor may be based on the number of blackouts for a restaurant during a particular day, week or month (e.g., the number of times a restaurant has, via the merchant computing device 250 of FIG. 2, blocked or otherwise prevented reservations from being made at the restaurant via the discount services; the number of times a restaurant has been completely book by users or the number of times a restaurant's time slots for reservations have been full, or a combination of the two). The business demand factor may be based on the number of knockouts for the restaurant during a particular day, week or month (e.g., a user may be able to remove one of the restaurants of the hub displayed in FIG. 6 from consideration as the “Hot Spot” discount and each instance this occurs for a restaurant, a knockout may be recorded for that restaurant in the historical database).

Indeed, the discount to be determined may be redeemable by a user on the current day. In such embodiments, the business demand factor may be the z-score determined based on data describing the above examples and such data may be retrieved from the historical database. For example, the business demand factor may be the z-score for the business determined according to the number of special discounts that were skipped during the prior day, week or month. The number of skips may be grouped according to restaurant (e.g., the number of skips for the restaurant are calculated against the number of skips for the other restaurants of the hub) or according to food type (e.g., if the restaurant is an Italian restaurant, the number of skips for Italian restaurants are calculated against the number of skips for one or more other types of food such as Mexican, French, burger, steak, and the like). In another example, the business demand factor may be the z-score for the business determined according to the number of number of restaurant blackouts or knockouts. The following table provides example z-scores determined according to the number of skips, which have been grouped by restaurants of a hub. As seen in Table 4, determining the z-score may include determining a standard deviation of the number of skips. Additionally, the number of skips may be set as a negative number in view of a skip being indicative of decreased demand for that restaurant.

TABLE 4
Example Z-Scores For Business Demand

| LOCATION | Big Deal Skips | Z Score | |
|---|---|---|---|
| Risotto Italiano | −40 | −1.3 | |
| Japanese Garden | −35 | −0.9 | |
| Tuna Mexicana | −12 | 0.9 | |
| Bombay Palace | −18 | 0.5 | |
| Prime Steakhouse | −6 | 1.4 | |
| Greek Olive | −30 | −0.5 | |
| Paris Café | −24 | 0.0 | |
| AVERAGE | −23.6 | ST DEV | 12.35 |

After determining the business demand factor (e.g, if the restaurant is Risotto Italiano of FIG. 7, the business demand factor may be −1.3 per Table 4), the business demand factor may be multiplied by the weight assigned to the business demand factor. In some arrangements, the weights may be equal to or based on the standard deviation determined for the demand factor. For example, the result of multiplying the business demand factor (e.g., −1.3) and the assigned weight (e.g., 12.35) may be used to adjust the baseline data (e.g., add the result to the number of average diners at the various discount levels). In this example, because the z-score chosen for the hub business demand factor is negative, the baseline data may be adjusted down (e.g., by 16 diners).

At step 1612, the computing platform may adjust the baseline data based on a hub weather demand factor. In some embodiments, the hub weather demand factor may be based on the number of diners that ate at restaurants of the hub during a particular type of weather, based on the hub's discount redemption rate during a particular type of weather, or based on the number of times a special discount was requested for the hub during a particular type of weather. Indeed, the discount to be determined may be redeemable by a user on the current day. In such embodiments, the computing platform may determine what type of weather is currently being experienced at the hub (e.g., fair, bad or severe) and may determine a z-score based on the current weather and weather information retrieved from the historical database.

For example, the hub weather demand factor may be the z-score for the current weather determined according to the number of diners at the restaurant's hub during the same type of weather. In another example, the hub weather demand factor may be the z-score for the current weather determined according to the number of times a “Hot Spot” discount was requested for the hub (e.g., requested via a press of the button for a “Hot Spot” discount as illustrated in FIG. 6) during prior instances of the same type of weather. In yet another example, the hub weather demand factor may be the z-score for the current weather determined according to the redemption rate for discounts of active users during prior instances of the same type of weather. The following table provides example z-scores determined according to the redemption rate of active users and, in some embodiments, may be used as the hub weather demand factor. As seen in Table 5, determining the z-score may include determining a standard deviation of the redemption rate. In this example, because fair weather is assumed to occur more frequently than bad or severe weather, the average may be determined as a weighted average (e.g., 103.8).

TABLE 5
Z-Scores For Hub Weather Demand Factor

| WEATHER | DINERS | Z Score | |
|---|---|---|---|
| Fair | 120 | 0.3 | |
| Bad | 45 | −1.1 | |
| Severe | 20 | −1.6 | |
| AVERAGE | 103.8 | ST DEV | 52.04 |

After determining the hub weather demand factor for the current weather (e.g, if the current weather is fair, the hub weather demand factor may be 0.3 per Table 5), the hub weather demand factor may be multiplied by the weight assigned to the hub weather demand factor. In some arrangements, the weights may be equal to or based on the standard deviation determined for the demand factor. For example, the result of multiplying the hub weather demand factor (e.g., 0.3) and the assigned weight (e.g., 52.04) may be used to adjust the baseline data (e.g., add the result to the number of average diners at the various discount levels). In this example, because the z-score chosen for the hub weather demand factor is positive, the baseline data may be adjusted up (e.g., by 16 diners).

At step 1614, the computing platform may determine, based on the adjusted baseline data, an expected total profit, total revenue and/or demand, at each discount level. The expected total profit and/or revenue may be determined based on the adjusted average diners and the average discount profit.

At step 1616, the computing platform may determine, based on the total profit and/or total revenue, a discount. In some arrangements, the discount may be determined as the discount level that provides the maximum or highest expected total profit. In others, the discount may be determined as the discount level that provides the maximum or highest expected total revenue. Table 6 provides an example that illustrates expected total profits and expected total revenues after the baseline data has been adjusted. As illustrated by Table 6, the discount that provides the highest total profit is 30% and the discount that provides the highest revenue is 35%. The computing platform may select and offer either of the discounts to a user (e.g., provide the discount as the big discount at step 30 of FIG. 3G; or provide the discount along with other similarly-calculated discounts for other businesses at step 22 of FIG. 3E).

TABLE 6
Total Profit and Total Revenue After Adjusting Baseline Data

| | Average | Average | Adjusted | | |
|---|---|---|---|---|---|
| Discount | Discount | Discount | Average | | Total |
| Level | Price | Profit | Diners | Total Profit | Revenue |
| 0% | $20.00 | $14.00 | 51 | $714.00 | $1,020.00 |
| 5% | $19.00 | $13.00 | 71 | $923.00 | $1,349.00 |
| 10% | $18.00 | $12.00 | 91 | $1,092.00 | $1,638.00 |
| 15% | $17.00 | $11.00 | 111 | $1,221.00 | $1,887.00 |
| 20% | $16.00 | $10.00 | 131 | $1,310.00 | $2,096.00 |
| 25% | $15.00 | $9.00 | 151 | $1,359.00 | $2,265.00 |
| 30% | $14.00 | $8.00 | 171 | $1,368.00 | $2,394.00 |
| 35% | $13.00 | $7.00 | 191 | $1,337.00 | $2,483.00 |
| 40% | $12.00 | $6.00 | 201 | $1,206.00 | $2,412.00 |
| 45% | $11.00 | $5.00 | 211 | $1,055.00 | $2,321.00 |
| 50% | $10.00 | $4.00 | 226 | $904.00 | $2,260.00 |
| 55% | $9.00 | $3.00 | 231 | $693.00 | $2,079.00 |
| 60% | $8.00 | $2.00 | 236 | $472.00 | $1,888.00 |
| 65% | $7.00 | $1.00 | 241 | $241.00 | $1,687.00 |
| 70% | $6.00 | $ — | 236 | $ — | $1,416.00 |
| 75% | $5.00 | $(1.00) | 231 | $(231.00) | $1,155.00 |

While aspects of the disclosure have been described with respect to specific embodiments, numerous modifications are possible. For example, in some embodiments, one or more base discounts and/or one or more randomly-selected discounts may be generated by and/or on a user computing device (e.g., instead of being generated on a computing platform located remotely from the user computing device). Thus, although aspects of the disclosure have been described with respect to specific embodiments, it will be appreciated that the disclosure is intended to encompass any and all modifications and equivalents within the scope of the appended claims.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A method, comprising:
providing, by a computing device, to a user computing device, two or more base discounts for a user of the user computing device;
receiving, by the computing device, from the user computing device, a request for a randomized discount for the user of the user computing device;
in response to receiving the request for the randomized discount for the user of the user computing device, selecting, by the computing device, using a randomized process, a merchant from a group of at least two merchants, the at least two merchants being grouped based on geographical proximity of the at least two merchants;
determining, by the computing device, a discount that is redeemable by the user of the user computing device with the selected merchant based on one or more factors including one or more of current weather or an amount of distance between an intended recipient of the determined discount and the selected merchant; and
providing, by the computing device, to the user computing device, the determined discount,
wherein the two or more base discounts for the user of the user computing device include at least one base discount for each merchant of the at least two merchants, and
wherein the determined discount that is redeemable by the user of the user computing device with the selected merchant provides a larger discount than a base discount for the selected merchant.

2. The method of claim 1, wherein the one or more factors further include at least one of time of day, day of year, user-specific preferences, use-specific factors, and one or more popularity factors.

3. (canceled)

4. The method of claim 2, wherein the one or more popularity factors include one or more general popularity factors and one or more relative popularity factors.

5. The method of claim 1, wherein a time limit prevents the user of the user computing device from requesting a second randomized discount until a predetermined amount of time elapses after the determined discount is determined.

6. The method of claim 1, wherein the geographical proximity of the at least two merchants is determined based on business locations of the at least two merchants being physically located within a predetermined distance of each other.

7. The method of claim 6, wherein each merchant of the at least two merchants is a restaurant.

8. The method of claim 1, further comprising:
prior to receiving the request for the randomized discount, providing, by the computing device, to the user computing device, hub listing information identifying one or more hubs; and
receiving, by the computing device, from the user computing device, hub selection information identifying a hub selected by the user of the user computing device, the hub including the at least two merchants.

9. The method of claim 1, further comprising:
receiving, by the computing device, from the user computing device, discount selection information identifying a first discount selected by the user of the user computing device.

10. The method of claim 9, further comprising:
receiving, by the computing device, from the user computing device, reservation information including reservation details provided by the user of the user computing device for a first merchant associated with the first discount; and
providing, by the computing device, to a merchant computing device associated with the first merchant, booking information including the reservation details.

11. The method of claim 10, further comprising:
receiving, by the computing device, from the user computing device, check-in information identifying a location of the user computing device;
validating, by the computing device, the check-in information;
based on validating the check-in information, requesting, by the computing device, from the user computing device, a merchant redemption code;
receiving, by the computing device, from the user computing device, redemption information including merchant code input; and
validating, by the computing device, the redemption information.

12. The method of claim 11, further comprising:
based on validating the redemption information, generating, by the computing device, billing information for the first merchant.

13. The method of claim 9, further comprising:
updating, by the computing device, relative popularity data for the group of the at least two merchants based on the discount selection information.

14. The method of claim 13, further comprising:
determining, by the computing device, at least one base discount based on the updated relative popularity data for the group of the at least two merchants.

15. The method of claim 1, wherein determining the discount comprises:
determining baseline data for the group of at least two merchants;
adjusting the baseline data based on a plurality of factors, wherein the plurality of factors includes a first factor based on a discount redemption rate for the group of at least two merchants during a particular day of the week, a second factor based on a number of successful check-ins at the group of at least two merchants during a particular interval of time, a third factor based on a number of discounts that were offered to users but not selected by the users, and a fourth factor based on a discount redemption rate for the group of at least two merchants during a particular type of weather;
after adjusting the baseline data, determining, for a plurality of different discount levels, an expected total profit or total revenue based on the baseline data; and
determining which of the plurality of different discount levels provides a maximum of the expected total profit or total revenue.

16. A method, comprising:
presenting, by a computing device, hub listing information identifying one or more hubs;
receiving, by the computing device, a selection of a first hub of the one or more hubs, the first hub including a group of at least two merchants, the at least two merchants being grouped into the first hub based on geographical proximity;
receiving, by the computing device, a request for a randomly-selected randomized discount;
based on receiving the request for the randomly-selected randomized discount, presenting, by the computing device, a first discount that is redeemable with a randomly-selected merchant of the at least two merchants;
presenting, by the computing device, two or more base discounts, wherein the two or more base discounts include at least one base discount for each merchant of the at least two merchants other than the randomly-selected merchant;
receiving, by the computing device, a selection of one of the presented discounts; and
communicating, by the computing device, discount selection information identifying the selected discount,
wherein the first discount that is redeemable with the randomly-selected merchant of the at least two merchants is determined based on one or more factors, the one or more factors including one or more of current weather or an amount of distance between an intended recipient of the first discount and the randomly-selected merchant, and
wherein the first discount that is redeemable with the randomly-selected merchant provides a larger discount than each base discount of the two or more base discounts.

17. The method of claim 16, further comprising:
receiving, by the computing device, a request to check-in at a current location;
determining, by the computing device, the current location of the user computing device; and
communicating, by the computing device, check-in information identifying the current location of the user computing device to facilitate redemption of the selected discount.

18. A method, comprising:
providing, by a computing device, two or more base discounts;
receiving, by the computing device, a request for a randomized discount;
in response to receiving the request for the randomized discount, selecting, by the computing device, a merchant from a hub, the hub including at least two merchants grouped based on geographical proximity of business locations of the at least two merchants;
determining, by the computing device, a discount for the selected merchant based on one or more factors including one or more of current weather or an amount of distance between an intended recipient of the determined discount and the selected merchant; and
causing, by the computing device, the determined discount for the selected merchant to be presented,
wherein the two or more base discounts include at least one base discount for each merchant of the at least two merchants, and
wherein the determined discount for the selected merchant provides a larger discount than a base discount for the selected merchant.

19. The method of claim 18, wherein the geographical proximity of the business locations of the at least two merchants is determined based on each of the business locations being physically located within a predetermined distance of each other.

20. The method of claim 18, wherein the one or more factors further include at least one of time of day, day of year, user-specific preferences, use-specific factors, and one or more popularity factors.

21. The method of claim 15, further comprising:
after providing the determined discount to the user computing device, updating, by the computing device, a historical database that stores the baseline data for the group of at least two merchants, the historical database including data for determining future discounts for other users different from the user of the user computing device.
